(19) United States
(12) Patent Application Publication
(10) Pub. No.: US 2025/0142516 A1
(43) Pub. Date: May 1, 2025

(54) ADAPTIVE ON-DEMAND POSITIONING

(71) Applicant: InterDigital Patent Holdings, Inc., Wilmington, DE (US)

(72) Inventors: Fumihiro Hasegawa, Westmount (CA); Yugeswar Deenoo Narayanan Thangaraj, Chalfont, PA (US); Jaya Rao, Montreal (CA); Paul Marinier, Brossard (CA); Moon IL Lee, Melville, NY (US)

(73) Assignee: InterDigital Patent Holdings, Inc., Wilmington, DE (US)

(21) Appl. No.: 18/730,537

(22) PCT Filed: Feb. 7, 2023
(86) PCT No.: PCT/US2023/062145

§ 371 Date: Jul. 19, 2024

Related U.S. Application Data
(60) Provisional application No. 63/308,295, filed on Feb. 9, 2022.
(60) Provisional application No. 63/334,729, filed on Apr. 26, 2022.
(60) Provisional application No. 63/409,967, filed on Sep. 26, 2022.

(51) Int. Cl. H04W 64/00

(52) U.S. Cl. CPC H04W 64/00

(57) ABSTRACT

A WTRU may be configured to perform adaptive on-demand positioning. The WTRU may receive configuration information for receiving positioning signals (PRSs) from a first set of one or more TRPs. For example, the configuration information may comprise PRS configuration information associated with each of the first set of TRPs. The WTRU may determine a metric (e.g., a weight, rank, etc.) associated with TRP that is not included in the first set of one or more TRPs. For example, the metric may be determined (e.g., using an AI/ML model) based on: a location associated with the TRP, a location associated with the WTRU, and/or a measurement associated with the TRP. The WTRU may send a PRS activation request to activate PRS from the TRP. For example, the PRS activation request may indicate the PRS configuration that the WTRU requests be activated, and a metric associated with that PRS configuration.

### CROSS REFERENCE TO RELATED APPLICATIONS

This application claims the benefit of U.S. Provisional Patent Application No. 63/308,295, filed Feb. 9, 2022; U.S. Provisional Patent Application No. 63/334,729, filed Apr. 26, 2022; and U.S. Provisional Patent Application No. 63/409,967, filed Sep. 26, 2022, which are hereby incorporated by reference in their entireties.

### BACKGROUND

Certain downlink (DL) and uplink (UL) positioning methods are used in certain wired/wireless communication protocols.

As described herein, DL positioning methods may refer to any positioning method that uses DL reference signals, such as primary synchronization signals (PRS). A WTRU may receive one or more reference signals from one or more transmission points (TPs) and measure a DL reference signal time difference (RSTD) and/or reference signal received power (RSRP), for example. Exemplary DL positioning methods may include DL angle of departure (DL-AoD) positioning and/or DL time difference of arrival (DL-TDOA) positioning.

### SUMMARY

A wireless transmit/receive unit (WTRU) may be configured to perform adaptive on-demand positioning (e.g., by transmitting adaptive positioning reference signal (PRS) activation requests). The WTRU may receive configuration information that indicates that the WTRU is configured to receive positioning signals (PRSs) from a first set of one or more transmission-reception points (TRPs). For example, the configuration information may comprise positioning reference signal (PRS) configuration information associated with the first set of TRPs (e.g., each of the TRPs in the first set of TRPs). The WTRU may determine a metric (e.g., a weight, rank, etc.) associated with a transmission-reception point (TRP) that is not included in the first set of one or more TRPs. For example, the metric may be determined based on one or more of: a location associated with the TRP, a location associated with the WTRU, and/or a measurement associated with the TRP. The WTRU may send a PRS activation request to activate PRS from the TRP. For example, the PRS activation request may indicate the PRS configuration (e.g., the TRPs and/or respective PRS resources to activate) that the WTRU requests be activated. The PRS activation request may include the determined metric associated with the TRP/PRS configuration. In response to the PRS activation request, the WTRU may receive a message indicating that the WTRU is to receive PRS from the TRP. For example, the message indicating that the WTRU is to receive PRS from the TRP may comprise PRS configuration information associated with the TRP.

In certain scenarios, the metric associated with the TRP may include a weight. The WTRU may determine a respective weight for each TRP in a second set of one or more TRPs. The WTRU may not be configured to receive PRS from each TRP of the second set of one or more TRPs. The PRS activation request transmitted by the WTRU may further comprise the respective weight determined for each TRP of the second set of one or more TRPs.

As described herein, the PRS activation request transmitted by the WTRU may include the location associated with the WTRU. The WTRU may receive PRS from the TRPs in the first set of one or more TRPs. The WTRU may determine the location associated with the WTRU (e.g., the WTRU's estimate location) based on the PRS received from the first set of one or more TRPs. For example, the WTRU may determine its location using measurements performed on the received PRSs (e.g., a reference signal received power (RSRP) measurement, a line of sight (LOS) measurement, a non-line of sight (NLOS) measurement, a distance measurement, a timing measurement, and/or the like). The WTRU's location may change over time. The WTRU may estimate it location at a given point in time based on the received PRSs. The WTRU may transmit an indication of its location. For example, the WTRU may indicate its location as a differential value (e.g., relative to the determined location associated with the WTRU based on the PRS received from the first set of one or more TRPs).

The WTRU may use an artificial intelligence/machine learning (AI/ML) model to perform positioning and/or to transmit PRS activation request. For example, the WTRU may use the AI/ML model to determine the weights included in PRS activation requests. Also, or alternatively, the WTRU may use an AI/ML model to determine its location (e.g., the WTRU's estimated location). For example, the measurements performed on the received PRSs, the location of the respective TRPs from which PRS(s) are received, and/or the WTRU location may be input to the AI/ML model. Based on the inputs, the AI/ML model may output the weights to be included in PRS activation requests. Also, or alternatively, the AI/ML model may output the WTRU's estimated location.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example associated with a neural network;

FIG. 3 illustrates an example associated with a WTRU requesting activation for a set PRS resources for a set of TRPs;

FIG. 4 illustrates an example hierarchical structure associated with a PRS configuration;

FIG. 5 illustrates an example associated with measurements and TRPs;

FIG. 6 illustrates an example associated with a WTRU being configured to request PRS resources;

FIGS. 7A-7C illustrate examples associated with weight determinations that may be used for positioning;

FIG. 8A illustrates an example associated with thresholds for activating TRPs;

FIG. 8B illustrates an example associated with PRS configurations for activated TRPs; and

FIG. 8C illustrates an example associated with activation requests for TRPs.

### DETAILED DESCRIPTION

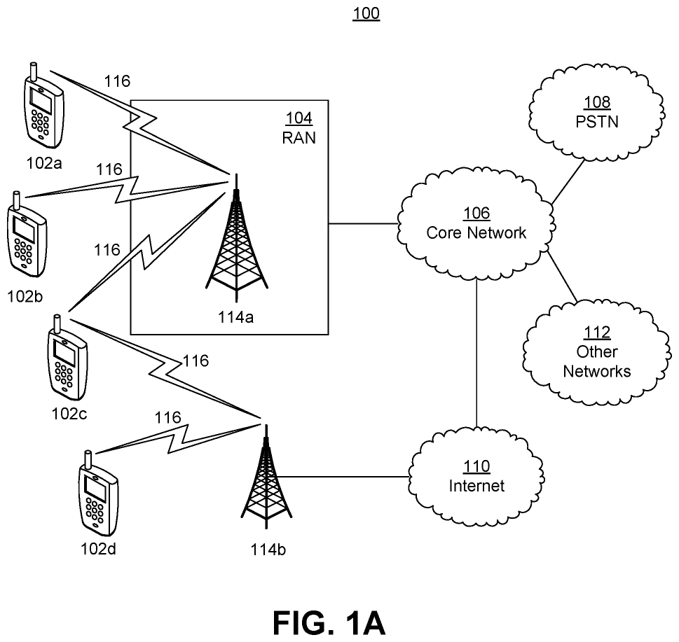

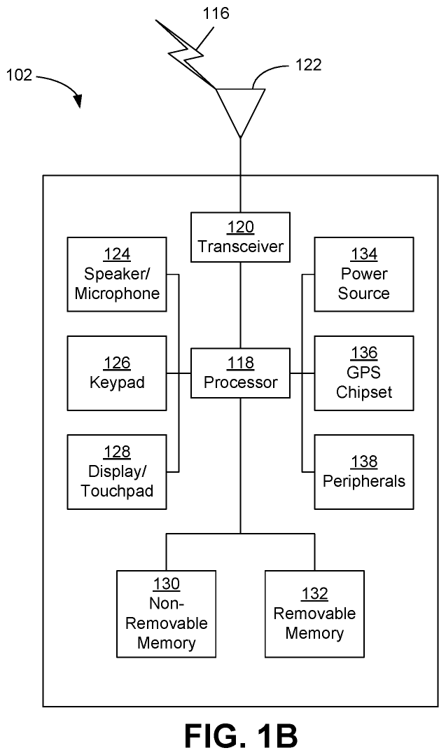

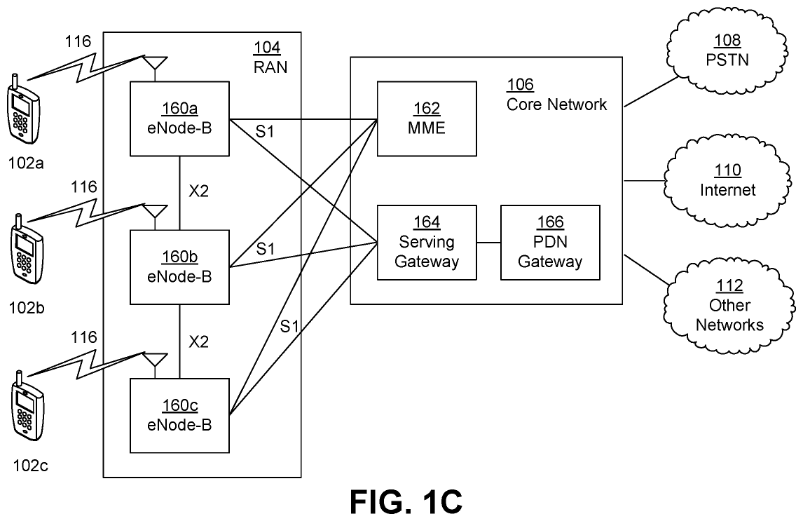

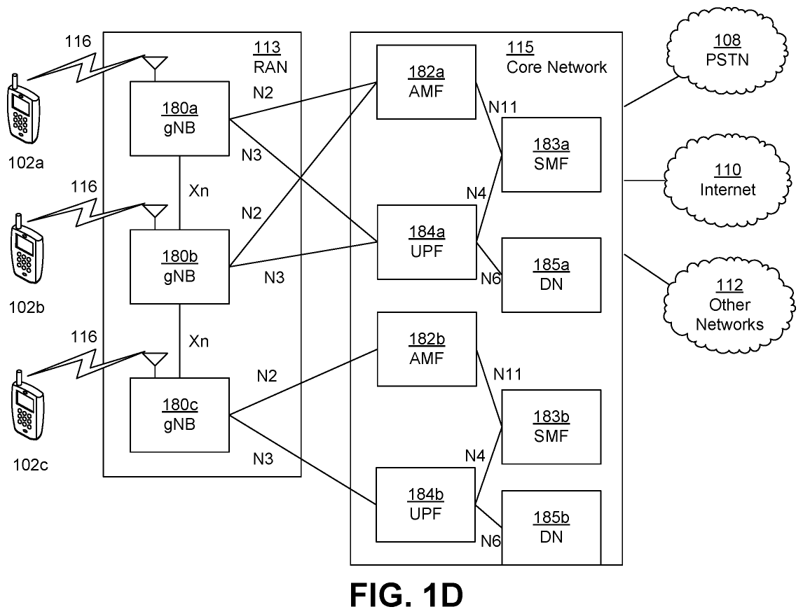

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHz, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

As described herein, DL positioning methods may refer to any positioning method that uses downlink reference signals, such as, positioning reference signals (PRS). A WTRU may receive one or more (e.g., multiple) reference signals from transmission points (TPs) and measure DL reference signal time difference (RSTD), Reference Signal Received Power (RSRP), a line of sight (LOS) measurement, a non-line of sight (NLOS) measurement, a distance measurement (e.g., a distance between the WTRU and a given TRP), or a timing measurement. Examples of DL positioning methods are DL-AoD or DL-TDOA positioning.

As described herein, UL positioning methods may refer to any positioning method that uses UL reference signals, such as, sounding reference signals (SRS), for positioning. A WTRU may transmit SRS to one more reception points (RPs) and the RPs may be configured to measure the UL relative time of arrival (RTOA) and/or UL reference signal receive power (RSRP). Example UL positioning methods may include UL time difference of arrival (UL-TDOA) positioning and/or UL angle of arrival (UL-AoA) positioning.

As described herein, DL positioning methods may refer to any positioning method that uses DL reference signals, such, as positioning reference signals (PRS), for positioning. A WTRU may receive one or more reference signals from transmission points (TPs), The WTRU may measure the DL reference signal time difference (RSTD) and/or RSRP. Example DL positioning methods may include DL-AoD and/or DL-TDOA positioning.

As described herein, DL & UL positioning methods may refer to any positioning method that uses both UL and DL reference signals for positioning. In an example, a WTRU may be configured to transmit SRS to one or more transmission-reception points (TRPs) and the network (e.g., one or more gNBs) may measure the reception-transmission (Rx-Tx) time difference. The network may, for example, measure RSRP for the received SRS. The WTRU may be configured to measure the Rx-Tx time difference for one or more positioning reference signals (PRS) transmitted from one or more TRPs. The WTRU may also be configured measurements (e.g., RSRP, LOS, NLOS, timing, etc.) for the received PRS. The Rx-TX time difference and/or the RSRP measured at the WTRU and/or the network (e.g., gNB) may be used to compute one or more metrics (e.g., round trip time). As described herein Rx-Tx time difference refers to the difference between arrival time of the reference signal transmitted by the TRP and transmission time of the reference signal transmitted from the WTRU. Exemplary DL & UL positioning methods may include multiple round-trip times (multi-RTT) positioning.

Artificial intelligence (AI) may be used in certain positioning techniques. As described herein, AI may refer to the behavior exhibited by machines that mimics cognitive functions to sense, reason, adapt and/or act.

Machine learning (ML) may be used in certain positioning techniques. As described herein, ML may refer to types of algorithms that solve problems based on learning through experience (e.g., data), without explicitly being programmed (e.g., a configuring set of rules). Machine learning may also, or alternatively, be considered as a subset of AI. Different ML paradigms may be envisioned based on the nature of data or feedback available to the ML system. For example, a supervised learning approach may involve a machine learning system learning a function that maps one or more inputs to one or more outputs. The mapping of inputs to outputs may be based on labeled training examples, wherein each labeled training example may include an exemplary pair of inputs and the corresponding output. For example, unsupervised learning may include detecting patterns in a data set that does not include pre-existing labels. For example, reinforcement learning may include performing a sequence of actions in an environment to maximize the cumulative reward. In certain scenarios, machine learning algorithms may be implemented using a combination and/or interpolation of the above-mentioned approaches. For example, a semi-supervised learning approach may include a combination of labeled date (e.g., a small amount of labeled data) with unlabeled data (e.g., a large amount of unlabeled data) during training. In this regard, semi-supervised learning may fall between unsupervised learning (e.g., without labeled training data, as described) and supervised learning (e.g., with labeled training data, as described).

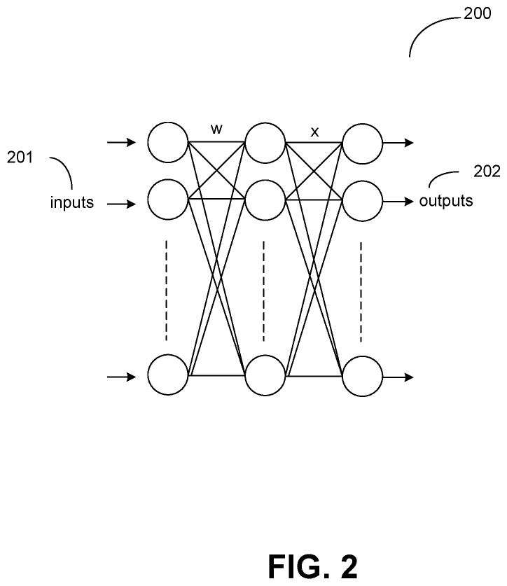

Neural networks may be used to perform certain positioning techniques. An example associated with a neural network 200 is shown in Error! Reference source not found. As shown in FIG. 2, the neural network 200 may be trained, for example, by applying one or more inputs 201 and adjusting the associated weights (e.g., indicated as w and x in FIG. 2), such that the output 202 from the neural network 200 approaches the desired target values that are associated with given input values. In certain scenarios, a neural network may include multiple layers (e.g., 2 layers). During the training for a given input, the difference between the output and the desired values may be computed. The difference between the output and the desired values may be used to update the weights in the neural network. For example, a direct relationship between the difference between output and desired values, and weight adjustments may exist. In certain scenarios, for example, if the difference between output and desired values is high (e.g., higher than a threshold), a large change in the relevant weights is expected. Similarly, if the difference between output and desired values is low (e.g., lower than a threshold), a small change in the relevant weights is expected.

As described herein, neural networks may be used in certain positioning techniques. In positioning, for example, inputs to the neural network may include reference signal parameters (e.g., RSRP measurements, WTRU location, TRP location, etc.) and outputs from the neural network may include and estimated position (e.g., an estimated position of WTRU). In certain scenarios, the desired value may include location information (e.g., location information acquired by the Global Navigation Satellite System (GNSS).

After training, a neural network may be used for positioning techniques, for example, by feeding inputs to the neural network, where the output of the neural network may be an expected outcome for the associated input. For example, the output of the neural network may include an estimated position or location of a WTRU and/or a weight associated with a PRS configuration (e.g., TRP and/or PRS resources from a given TRP). An example of estimated position may be the location of the WTRU approximately when the WTRU made measurements on the received PRS. The output of the neural network may also, or alternatively, include a predicted position or location of a WTRU. For example, a predicted position of the WTRU may be a future position of the WTRU.

With respect to training a neural network for positioning and/or PRS activation requests (e.g., training a neural network to estimate the position or location of a WTRU), one or more of the following may be identified: the inputs for the neural network; an expected output(s) associated with each input; and/or the actual output from the neural network, against which the target values may be compared against

As described herein, a neural network may be characterized by one or more of the following parameters: the number of weights; and/or the number of layers in the neural network.

Deep Learning (DL) may be used in certain positioning techniques. As described herein, DL may refer to certain machine learning algorithms, for example, that employ artificial neural networks (e.g., deep neural networks (DNNs), which were loosely inspired from biological systems). DNNs may include a class of machine learning models where the input is transformed (e.g., linearly transformed) and passed through certain functions (e.g., non-linear activation function). For example, the transferred inputs may be passed through the functions of a DNN multiple times. DNNs may also include multiple layers, and each layer may include one or more transformation functions (e.g., linear transformation and/r non-linear activation functions). DNNs may be trained, for example, using training data via a back-propagation algorithm. DNNs have been used in a variety of applications, including, e.g., speech, vision, natural language etc. DNNs have also been used in various machine learning settings, including, for example, supervised applications, un-supervised applications, and semi-supervised applications. As described herein, an AI component may refer to realization of behaviors and/or conformance to requirements by learning based on data (e.g., without configuration of sequence or steps of actions). For example, an AI component may be used to learn complex behaviors, which might be difficult to specify and/or implement when using other methods. As used herein, the term network may include an access and mobility management function (AMF), a location management function (LMF), a gNB, and/or a radio access network (RAN) (e.g., a next generation RAN (NG-RAN)), AMF, LMF, gNB or NG-RAN. Similarly, the following terms may be used interchangeable: pre-configuration and configuration; “non-serving gNB” and “neighboring gNB”; gNB and TRP; PRS and “PRS resource”; PRS(s) and “PRS resource(s)” (e.g., PRS(s) or PRS resource(s) may belong to different PRS resource sets); PRS and DL-PRS or DL PRS; and/or “measurement gap” and “measurement gap pattern.” For example, a measurement gap pattern may include parameters, such as, measurement gap duration, measurement gap repetition period, and/or measurement gap periodicity.

As described herein, pre-configuration and configuration may be used interchangeably. As described herein, on-serving gNB and neighboring gNB may be used interchangeably. As described herein, gNB and TRP may be used interchangeably. As described herein, PRS and PRS resource may be used interchangeably. As described herein, PRS(s) and PRS resource(s) may be used interchangeably. As described herein, PRS(s) and PRS resource(s) may belong to different PRS resource sets. As described herein, PRS, DL-PRS, and DL PRS may be used interchangeably. As described herein, measurement gap and measurement gap pattern may be used interchangeably. For example, a measurement gap pattern may include one or more parameters, such as, a measurement gap duration, measurement gap repetition period, and/or measurement gap periodicity.

A positioning reference unit (PRU), as used herein, may include a WTRU or TRP whose location (e.g., altitude, latitude, geographic coordinate, or local coordinate) is known by the network (e.g., gNB, LMF). For example, the capabilities of a PRU may be similar to (e.g., the same as) a WTRU or TRP that is, for example, configured to: receive a positioning reference signal (PRS); transmit a sounding reference signal (SRS) (e.g., SRS for positioning); and/or transmit PRS. For example, WTRUs acting as PRUs may be used by the network for calibration purposes (e.g., to correct an unknown timing offset and/or to correct an unknown angle offset). In another example, WTRUs acting as PRUs may be configured to report measurements to the network.

As used herein, LMF may include a node or entity (e.g., a network node or entity) that may be used for or to support positioning. Other nodes or entities may also, or alternatively, be used and/or substituted for LMF.

The WTRU may be configured to receive thresholds (e.g., preconfigured threshold) from the network (e.g., LMF, gNB, etc.). A PRS configuration may be used to indicate (e.g., indicate to a WTRU) the TRP(s) from which a WTRU is configured to receive PRS from. For example, a PRS configuration may indicate the PRS resources associated with each of the TRP(s) that the WTRU is configured to receive PRS from. Certain PRS configurations (e.g., the TRP(s) from which a given WTRU receives PRS) may be configured such that it is assumed that the network has certain information that may be used to perform PRS and/or WTRU positioning (e.g., the location of a WTRU). However, in certain scenarios (e.g., due to unexpected WTRU movement, unexpected obstacles, etc.), the network may not have knowledge of the WTRU's location. If, for example, the network does not have knowledge of a WTRU's location), PRS configurations may be determined using an iterative process, which may increase latency in positioning. For example, a WTRU may be configured to transmit one or more PRS activation requests to obtain a desired PRS configuration (e.g., an on-demand framework). In such an on-demand framework, the WTRU may also, or alternatively, be configured to transmit a PRS activation request for a set of PRS configurations, which may further increase the number of iterations to find an optimum PRS configuration. In WTRU-based positioning, for example, networks may not receive measurements from the WTRU, and an optimal PRS configuration may not be available at the network.

Adaptive PRS activation requests may be used to perform positioning. For example, a PRS request procedure (e.g., an adaptive on-demand PRS request procedure) may be employed. As described herein, PRS is used an example reference signal (RS) that is used for positioning requests (e.g., on-demand positioning requests). However, any DL or UL RSs may also, or alternatively, be used for positioning requests, including, e.g., a channel state information RS (CSI-RS), a demodulation RS (DM-RS), a phase tracking RS (PT-RS), tracking reference signals (TRS), SRS, and/or the like. PRS request and PRS activation request may be used interchangeable herein. As described herein, PRS activation requests may be WTRU specific. For example, in certain scenarios, a PRS activation request transmitted by a given WTRU may turn on PRS from a TRP that is not currently transmitting PRS to other WTRUs, and in other instances a PRS activation request transmitted by a given WTRU may turn on PRS from a TRP that is currently transmitting PRS to other WTRUs.

A WTRU may transmit a measurement gap (MG) request and/or a PRS processing window request based one or more of the following: a PRS configuration (e.g., duration of PRS), and/or whether periodic/semi-persistent DL channels or RS is scheduled. The WTRU may determine the associated metric (e.g., weight, rank, etc.) for the request based on latency requirement.

A WTRU may determine to request to turn one or more PRS enabled TRPS on or off. For example, WTRU may determine metrics (e.g., weights, ranks, etc.) associated with the request based on LOS/NLOS indicator for the TRP.

A WTRU may be configured to perform adaptive on-demand positioning (e.g., by transmitting adaptive positioning reference signal (PRS) activation requests). The WTRU may receive configuration information that indicates that the WTRU is configured to receive positioning signals (PRSs) from a first set of one or more transmission-reception points (TRPs). For example, the configuration information may comprise positioning reference signal (PRS) configuration information associated with the first set of TRPs (e.g., each of the TRPs in the first set of TRPs). The WTRU may determine a metric (e.g., a weight, rank, etc.) associated with a transmission-reception point (TRP) that is not included in the first set of one or more TRPs. For example, the metric may be determined based on one or more of: a location associated with the TRP, a location associated with the WTRU, and/or a measurement associated with the TRP. The WTRU may send a PRS activation request to activate PRS from the TRP. For example, the PRS activation request may indicate the PRS configuration (e.g., the TRPs and/or respective PRS resources to activate) that the WTRU requests be activated. The PRS activation request may include the determined metric associated with the TRP/PRS configuration. In response to the PRS activation request, the WTRU may receive a message indicating that the WTRU is to receive PRS from the TRP. For example, the message indicating that the WTRU is to receive PRS from the TRP may comprise PRS configuration information associated with the TRP.

In certain scenarios, the metric associated with the TRP may include a weight. The WTRU may determine a respective weight for each TRP in a second set of one or more TRPs. The WTRU may not be configured to receive PRS from each TRP of the second set of one or more TRPs. The PRS activation request transmitted by the WTRU may further comprise the respective weight determined for each TRP of the second set of one or more TRPs.

As described herein, the PRS activation request transmitted by the WTRU may include the location associated with the WTRU. The WTRU may receive PRS from the TRPs in the first set of one or more TRPs. The WTRU may determine the location associated with the WTRU (e.g., the WTRU's estimate location) based on the PRS received from the first set of one or more TRPs. For example, the WTRU may determine its location using measurements performed on the received PRSs (e.g., a reference signal received power (RSRP) measurement, a line of sight (LOS) measurement, a non-line of sight (NLOS) measurement, a distance measurement, a timing measurement, and/or the like). The WTRU's location may change over time. The WTRU may estimate it location at a given point in time based on the received PRSs. The WTRU may transmit an indication of its location. For example, the WTRU may indicate its location as a differential value (e.g., relative to the determined location associated with the WTRU based on the PRS received from the first set of one or more TRPs).

The WTRU may use an artificial intelligence/machine learning (AI/ML) model to perform position and/or to transmit PRS activation request. For example, the WTRU may use the AI/ML model to determine the weights included in PRS activation requests. Also, or alternatively, the WTRU may use an AI/ML model to determine its location (e.g., the WTRU's estimated location). For example, the measurements performed on the received PRSs, the location of the respective TRPs from which PRS(s) are received, and/or the WTRU location may be input to the AI/ML model. Based on the inputs, the AI/ML model may output the weights to be included in PRS activation requests. Also, or alternatively, the AI/ML model may output the WTRU's estimated location.

A WTRU may be configured to perform adaptive on-demand positioning. The WTRU may be configured to receive a request (e.g., from the network) for the WTRU to return certain information associated with positioning requests (e.g., desired/requested PRS configurations and associated weights for the respective PRS configurations) and a list of TRPs that the WTRU is able to receive PRS from. As requested, the WTRU may be configured to transmit the requested information. Based on the information transmitted by the WTRU (e.g., information associated with positioning requests and/or the list of TRPs), the WTRU may be configured with a one or more TRPs from which PRS is to be received by the WTRU. The WTRU may perform measurements (e.g., RSRP, LOS, NLOS, timing, etc.) on the PRS received from the candidate TRPs. The WTRU may identify one or more TRPs that are not part of the one or more TRPs from which PRS is not received (e.g., candidate TRPs). If the average RSRP of the PRSs received from the one or more configured TRPs is below a threshold, the WTRU may determine certain information (e.g., soft metrics) associated with each candidate TRP. For example, the information associated with each of the candidate TRPs may be determined based on how close a respective candidate TRP is to the TRP with the highest RSRP. The WTRU may determine an estimated position of the WTRU, for example, based on the measurements performed on the PRS received from the one or more configured TRPs.

Based on the information associated with each of the candidate TRPs transmitted by the WTRU, the WTRU may be configured (e.g., by the network) with a new/updated set of TRPs from which PRS is to be received by the WTRU. The WTRU may perform measurements (e.g., RSRP measurements) on the PRS received from the new/updated set of TRPs. The WTRU may perform certain calculations on the measurements performed on the PRS received from the new/updated set of TRPs. If, for example, the average RSRP of the PRS received from the updated/new set of TRPs is greater than the threshold, the WTRU may determine to terminate the on-demand PRS procedure. Also, or alternatively, the WTRU determine to terminate the PRS activation request procedure if the number of iterations is above a threshold.

A WTRU may transmit a first PRS activation request. For example, the first PRS activation request may include an indication of one or more transmission-reception points (TRPs). In response to the first PRS activation request, the WTRU may receive configuration information (e.g., PRS configuration information). The PRS configuration information may include an indication of one or more TRPs from which the WTRU is configured to receive PRS from (e.g., configured TRPs). The WTRU may receive PRS from each of the one or more configured TRPs. The WTRU may perform reference signal received power (RSRP) measurements on the PRS received from each of the one or more configured TRPs. Based on the measurements performed on the PRS received from each of the one or more configured TRPs, the WTRU may calculate a metric associated with the one or more configured TRPs. The WTRU may determine that the metric associated with the one or more configured TRPs is below a threshold. For example, the threshold may be included in the PRS configuration information.

Based on the determination that the metric associated with the one or more configured TRPs is below the threshold; the WTRU may identify one or more candidate TRPs. For example, the one or more candidate TRPs may include a TRP that is closest to the TRP of the configured TRPs associated with the highest RSRP measurement. The WTRU may determine/identify the other TRPs that are in proximity to a TRP of the one or more configured TRPs associated with the highest RSRP measurement by determining, estimating, or otherwise ascertaining which TRP the WTRU believes is the closest TRP to the TRP of the configured TRPs associated with the highest RSRP measurement. The WTRU may transmit a second PRS activation request that includes an indication of the one or more candidate TRPs identified by the WTRU. The WTRU may estimate a location associated with the WTRU. For example, the location associated with the WTRU may be estimated based on the measurements performed on the PRS received from each of the one or more configured TRPs. The WTRU may include the estimated location associated with the WTRU in the second PRS activation request.

In response to the second PRS activation request, the WTRU may receive updated PRS configuration information. For example, the updated PRS configuration information may include an indication of one or more updated TRPs from which the WTRU is configured to receive PRS. The WTRU may receive PRS from one or more (or each) of the one or more updated TRPs. The WTRU may perform RSRP measurements on the PRS received from each of the one or more updated TRPs. The WTRU may calculate, based on the measurements performed on the PRS received updated TRPs, a metric associated with the updated TRPs. The WTRU may determine that the metric associated with the updated TRPs is greater than or equal to the threshold. Based on the determination that the metric associated with the updated TRPs is greater than or equal to the threshold, the WTRU may transmit an on-demand PRS termination request.

A WTRU may send a request to activate a PRS configuration information (e.g., TRP, PRS resource, PRS resource group, etc.) based on a condition. The WTRU may receive PRS configurations (e.g., PRS transmission periodicity) associated with the requested PRS configuration, which may be considered as an acknowledgement to the request to activate the PRS configuration.

A WTRU may be configured to transmit a request to change and/or update one or more parameters associated with PRS (e.g., the TRPs from which the WTRU receives PRS). Such a request to change and/or update one or more parameters associated with PRS may be referred to herein as a PRS request. For example, a WTRU may be configured to transmit a PRS request to the network (e.g., LMF, gNB) to change/update the WTRU's PRS configuration (e.g., to a requested value). The WTRU may, for example, be configured to transmit a PRS request to change/update the value of at least one of the following PRS configuration parameters: the number of symbols; the transmission power; the number of PRS resources included in PRS resource set; the muting pattern for PRS (e.g., the muting pattern may be expressed in bitmap); the periodicity; the type of PRS (e.g., periodic, semi-persistent, and/or aperiodic); the slot offset for periodic transmission for PRS; the vertical shift of PRS pattern in the frequency domain; the time gap during repetition; the repetition factor; the resource element (RE) offset; the comb pattern; the comb size; the spatial relation or Quasi Co Location (QCL) information (e.g., QCL target, QCL source, etc.) for PRS; the number of positioning reference units (PRUs); the number of TRPs; the absolute radio-frequency channel number (ARFCN); the subcarrier spacing; the expected reference signal time difference (RSTD) (e.g., including uncertainty in expected RSTD); the starting PRB; the bandwidth (e.g., the bandwidth part (BWP), number of resource elements, number of resource blocks, bandwidth expressed in Hz, etc.); the BWP ID; the number of frequency layers; the start/end time for PRS transmission; the on/off indicator for PRS; the TRP ID; the PRS ID; the cell ID, global cell ID, etc.; and/or the PRU ID. As described herein, this request may be referred to as an PRS activation request.

A WTRU may also, or alternatively, be configured to transmit a PRS request to the network, for example, if/when the requested PRS configuration becomes activated. For example, the WTRU may be configured to transmit a PRS request to the network to activate the requested TRPs or PRS resources at a defined: start time in terms of frame, slot, symbol number, etc.; start time in terms of absolute time; and/or a start time in terms of relative timing with respect to a reference time (e.g., N slots from the time the request was transmitted by the WTRU or received by the network)

A WTRU may be configured to transmit a PRS request to deactivate certain PRS parameters. For example, the WTRU may be configured to transmit a PRS request to the network to deactivate certain resources (e.g., the requested TRPs or PRS resources). The WTRU may be configured to transmit the PRS request to deactivate resources at: an (e.g., defined) end time in terms of frame, slot, symbol number, etc.; an end time in terms of absolute time; and/or an end time in terms of relative timing with respect to a reference time (e.g., N slots from the time the request was transmitted by the WTRU and/or received by the network)

For example, PRS requests to activate and/or deactivate certain PRS parameters may, for example, be transmitted via an LTE positioning protocol (LPP) message, a UL MAC control element (UL-MAC-CE), UL downlink control information (UL-DCI), and/or an RRC message.

A WTRU may be configured (e.g., pre-configured by the network) with the PRS parameters that the WTRU may change/update (e.g., PRS ID, repetition factor, etc.). As described herein, a WTRU may be configured by the network by receiving configuration information from the network. For example, the WTRU may be pre-configured with a range or set of values for each PRS parameter that the WTRU is able to change/update. As an example, if the WTRU is configured with the ability to change/update periodicity parameters for PRS, the WTRU may be pre-configured (e.g., by the network) with a set of periodicity values that may be set by the WTRU (e.g., pre-configured with three (3) periodicity values: [5 ms, 10 ms, 20 ms]). Each value in the set may further be associated with an ID. And when the WTRU transmits the request to change/update the relevant PRS parameter to the network, the request transmitted by the WTRU may include the ID and/or the name of the PRS parameter, which may decrease the size of the request. The WTRU may, for example, be configured to receive the pre-configuration from the network via LPP and/or an RRC message. If the WTRU is not pre-configured with the range or set of values, the WTRU may be configured to request a pre-configuration from the network.

A WTRU may also, or alternatively, be configured with an allowed PRS configuration set. For example, the WTRU may be pre-configured by the network with one or more allowed PRS configuration sets. Each allowed PRS configuration set may include one or more of the PRS parameters and the respective value/value range for the PRS parameters. Each allowed PRS configuration set may also, or alternatively, be associated with logical identity, and the WTRU may be configured to request a desired PRS configuration by including the logical identity of the desired PRS configuration within the allowed preconfigured set.

A WTRU may be configured with one or more default configuration set(s) and/or one or more of specific configuration sets. For example, the WTRU may be configured to indicate a desired PRS configuration by including a logical identity of default configuration from default configuration set. The WTRY may also, or alternatively be configured to indicate a desired PRS configuration by including a logical identity of a specific configuration from the specific configuration sets. For example, the desired PRS configuration may be determined based on a combination of default configurations and specific configurations, where the PRS parameter values from a specific configuration may override the parameter values from a default configuration.

As described herein, a WTRU may be configured to determine and/or adjust the metrics (e.g., weights, ranks, etc.) that are used for positioning. For example, a WTRU may be configured to receive an indication from the network (e.g., LMF, gNB) to associate certain weights with certain PRS parameters. The WTRU may be configured to receive a configuration (e.g., via configuration information) from the network. The configuration information may include the number of weights that a WTRU is to include in the request. For example, the WTRU may be pre-configured with a number of periodicities values (e.g., five (5) periodicity values: [1 ms, 5 ms, 10 ms, 20 ms, 50 ms]). The WTRU may receive a configuration from the network to return weights for a number of the periodicity values (e.g., 3 periodicity values) in the request. Based on the configuration, the WTRU may be configured to determine to associate weights for 1 ms, 5 ms and 10 ms, where the associated weights determined by the WTRU may be 0.1, 0.5 and 0.4, for 1 ms, 5 ms and 10 ms, respectively. The WTRU may determine the weights based on the measurements made on PRS received with the different periodicities. For example, the WTRU may be configured with PRSs that are transmitted from TRPs at periodicity of 1 ms. Based on the measurements, the WTRU may determine that average value of RSRP is larger than the preconfigured threshold. In that case, the WTRU may determine to request PRS with longer periodicity such that the number of measurement occasions can be reduced to prioritize reception of data or control channels. Thus, the WTRU may determine to assign weights to periodicities larger than 1 ms but within the number of parameters the WTRU can request (e.g., 3). Due to uncertainty in the request, the WTRU may assign a nearly equal number of weights to periodicity of 5 ms and 10 ms. For example, the WTRU may assign a larger weight for 5 ms since, for example, 5 ms is closer in periodicity to the currently configured periodicity of 1 ms.

A WTRU may be configured to receive certain threshold for determining the respective weights. For example, the WTRU may be configured to receive a threshold that indicates the minimum value of the associated weights from the network. If, for example, the value of a given weight is greater than or equal to the received threshold, the WTRU may determine to include the weight in the request. Similarly, if a weight associated with a given TRP (e.g., TRP0) is 0.1 and the minimum weight threshold pre-configured by the network is 0.3, the WTRU may not request the network to activate TRP0.

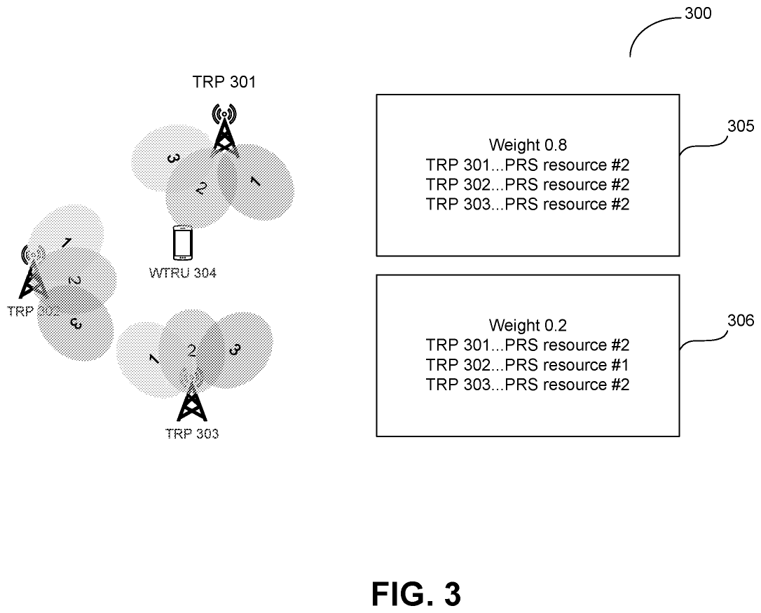

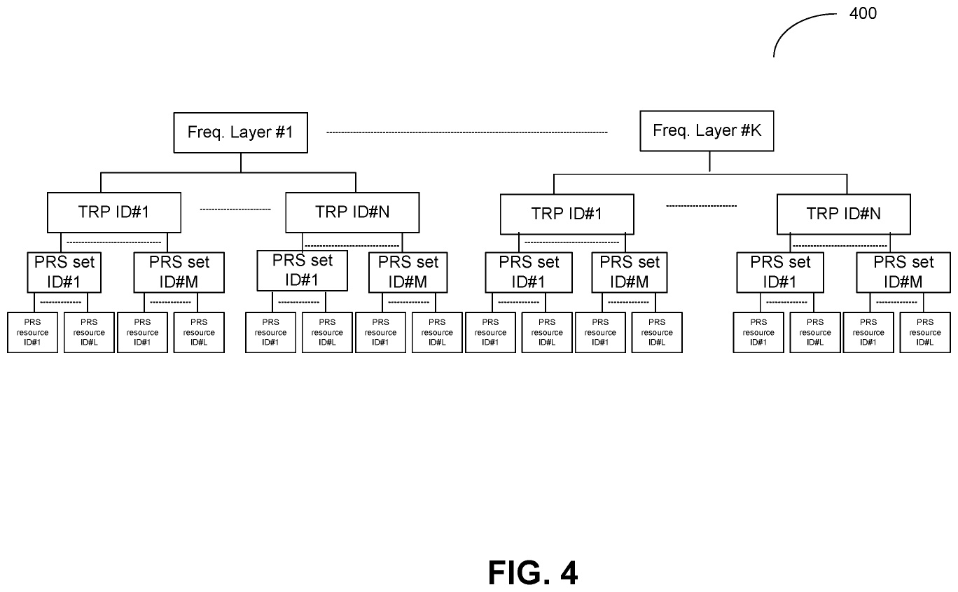

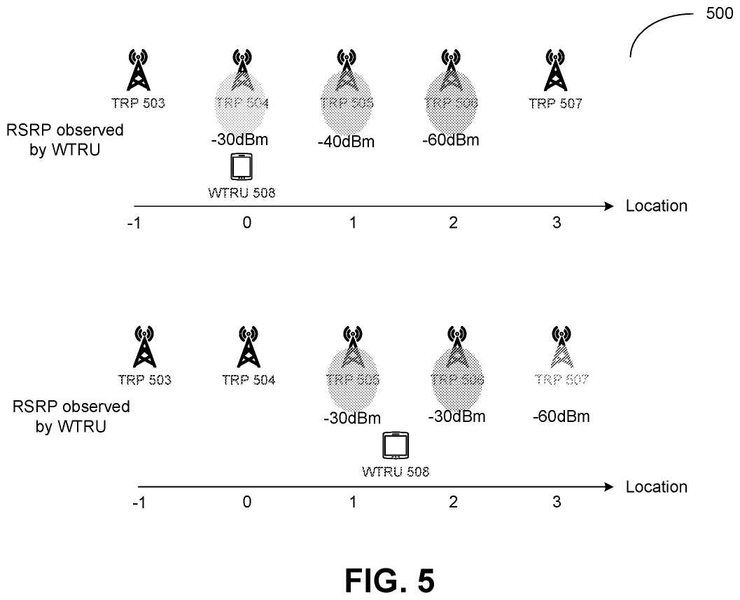

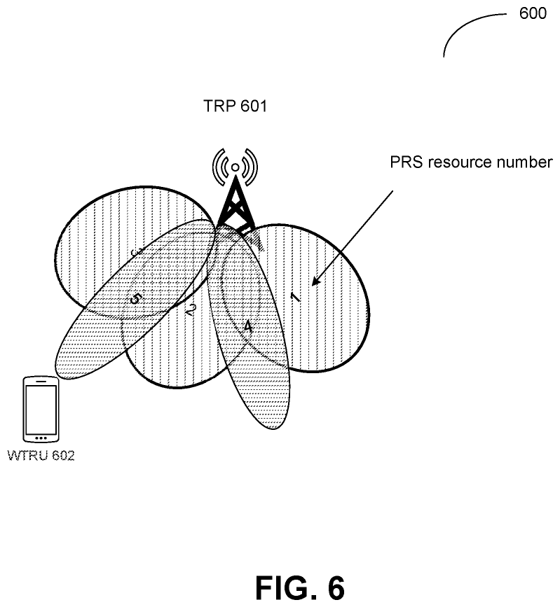

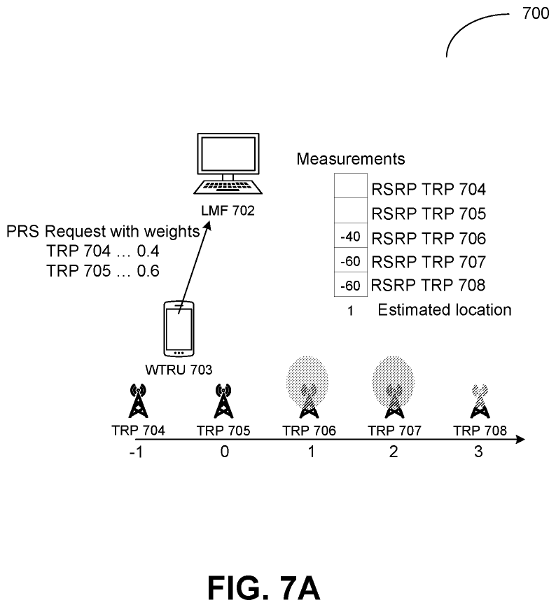

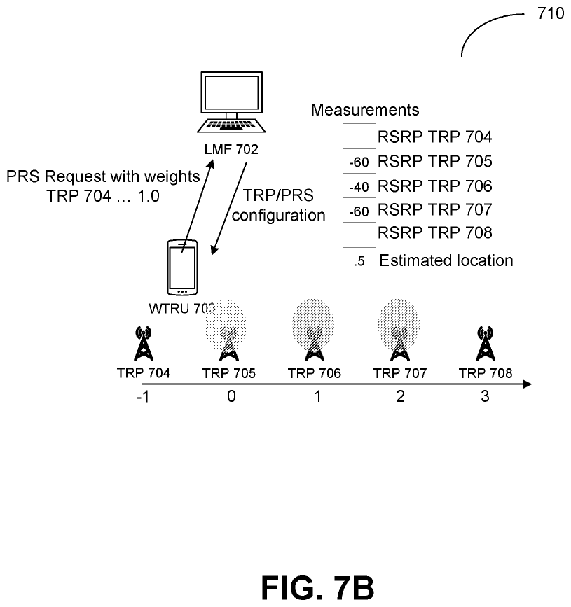

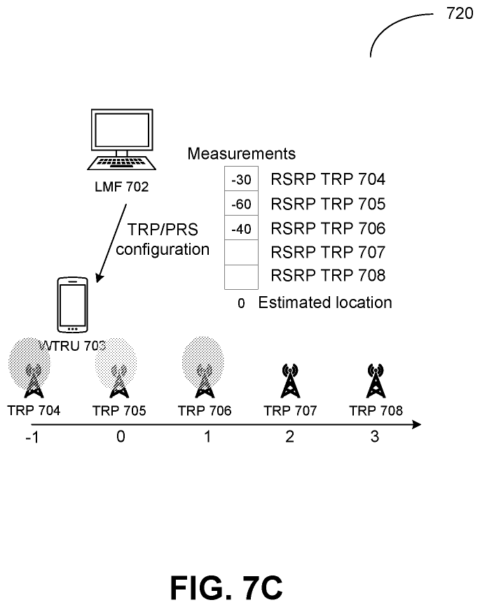

FIGS. 3-7C illustrate examples associated with PRS activation request techniques. FIG. 3 illustrates an example 300 associated with a WTRU requesting a set PRS resources for a set of TRPs. FIG. 4 illustrates an example hierarchical structure 400 associated with a PRS configuration. FIG. 5 illustrates an example 500 associated with measurements and TRPs. FIG. 6 illustrates an example 600 associated with a WTRU being configured to request PRS resources. FIGS. 7A-7C illustrate examples 700, 710, and 710, respectively, which are associated with weight determinations.

Referring to the example illustrated in FIG. 3, a WTRU 304 may be configured (e.g., via PRS configuration information) to receive PRS from TRPs 301, 302, and 303. For example, the WTRU 304 may be configured to receive PRS on PRS resources 1, 2, 3 from TRP 301; receive PRS on PRS resources 1, 2, 3 from TRP 302; and receive PRS on PRS resources 1, 2, and 3 from TRP 303. The WTRU may be configured to request a change or update to the PRS it received, for example, by transmitting a PRS request. The PRS request may indicate the PRS resources from which the WTRU 304 requests that PRS is received. The PRS request may include one or more PRS configurations. Each of the PRS configurations may be associated with a weight. For example, as shown in FIG. 3, the WTRU 304 may transmit a PRS request that includes one or requested PRS configurations. For example, as shown in FIG. 3, a first PRS configuration 305 may request to receive PRSs on PRS resource 2 from TRP 301, on PRS resource 2 from TRP 302, and on PRS resource 2 from TRP 303. As shown in the example illustrated in FIG. 3, the PRS request transmitted by WTRU 304 may include a second PRS configuration 306 that requests PRS be received on PRS resource 2 from TRP 301, on PRS resource 1 from TRP 302, and on PRS resource 2 from TRP 303. As described herein, each of the PRS configurations may be associated with a weight. As shown in FIG. 3, for example, the first PRS configuration 305 may be associated with a weight of 0.8, and the second PRS configuration 306 may be associated with a weight of 0.2. The PRS configurations 305, 306 and/or the respective weights assigned to the PRS configurations may be determined using an AI/ML model (e.g., the AI/ML model 200 illustrated in FIG. 2). For example, as described herein, one or more measurements (e.g., RSRP, LOS, NLOS, timing, etc.) associated with each of the TRPs/PRS resources may be input to the AI/ML model. Also, or alternatively, a location associated with the TRPs 301, 302, 303, and/or an estimate location of the WTRU 304 may be input to the AI/ML model. Based on the inputs, the AI/ML model may output a PRS configurations and/or the associated weights. As described herein, the WTRU 304 may use the PRS received to perform positioning. For example, the WTRU may provide measurements performed on the PRS, a location associated with the TRPs from which the TRPs are received, and/or a location (e.g., a previous location) of the WTRU as inputs to an AI/ML model, and the AI/ML model may output an estimated location of the WTRU.

It should also be appreciated that, although FIG. 3 illustrates an example where the WTRU 304 transmits PRS activation request to activate PRS from TRPs/PRS resources that it is already configured to receive PRS from, the WTRU 304 may also transmit PRS activation request for TRPs/PRS resources that are not yet configured. For example, based on the measurements performed by the WTRU 304 and/or the outputs of an AI/ML model, the WTRU 304 may transmit a PRS activation request to activate PRS from a TRP other than TRP 301, TRP 302, or TRP 303.

A WTRU may, for example, be configured to receive an indication to initiate a weight request process via LPP and/or RRC message. For example, one or more of the following may apply to the weights associated with certain PRS parameters: the weights associated with requests may add up to a given value (e.g., 1); each weight associated with a request may be a value greater than 0 and less than or equal to 1; and/or each weight may be either 0 or 1.

A WTRU may be configured to initiate a positioning request (e.g., an on-demand positioning request). For example, the WTRU may be configured to transmit a request to initiate a positioning request procedure (e.g., to the network). In response, the network may return certain parameters to initiate the positioning request procedure (e.g., parameters the WTRU can request, the number of parameters the WTRU can request, whether the WTRU returns weights associated with the parameters, the number of iterations, etc.)

Also, or alternatively, the WTRU may be configured to indicate to the network that the WTRU initiates an on-demand request procedure. For example, the WTRU may be configured to transmit the indication to the network after the WTRU receives the above mentioned parameters to initiate the procedure.

A WTRU may be configured to determine whether/when to transmit a request initiate an on-demand positioning request. For example, the WTRU may determine to transmit a request to initiate an on-demand positioning request based on one or more of the following: an average reference signal received power (RSRP) (e.g., and average RSRP of a received PRS being less than or equal to a threshold); the number of requests that the WTRU has transmitted to the network (e.g., being above or below a threshold); a variance in certain measurements (e.g., RSRP, ToA, RSTD, angle of arrival (AoA), angle of departure (AoD)) being greater than a threshold; the maximum value of a weight associated with PRS parameters is below a threshold (e.g., a pre-configured threshold); the WTRU receiving a trigger (e.g., via DCI) from the network to transmit an a (e.g., on-demand) positioning request that includes the weights associated with the respective PRS configurations; and/or the WTRU receiving an command or signal (e.g., via a MAC-CE) from the network (e.g., that is configured to trigger a PRS request procedure).

A WTRU may be configured to determine a set of PRS parameters to include in the PRS request. The WTRU may determine a set of parameter candidates for the request based on a condition (e.g., whether the measurements required to derive the weights are available or not). For example, the WTRU may determine to request the parameters that are not included in the pre-configurations (e.g., pre-configured set of TRPs, configured set of PRSs from which measurements are obtained, etc.).

In certain scenarios, a WTRU may be configured to determine a set of TRPs from which PRSs are received. For example, the WTRU may be configured to determine a set of TRPs from which PRSs are received by comparing a pre-configured set of parameters and training data. The set of TRPs from which PRSs are received may, for example, be included in pre-configured PRS parameters and/or may not be included in the set of TRPs from which the measurements are already received.

In certain scenarios, a WTRU may be configured to transmit a PRS request that includes the weights for certain parameters (e.g., the parameters that the WTRU is pre-configured with). For example, the WTRU may be configured to transmit the PRS request after the WTRU performs certain measurements/calculations on a given PRS configuration (e.g., the current PRS configuration). The WTRU may be configured to derive the weights of certain PRS parameters based on measurements/calculations on the PRS configuration. The WTRU may be configured to include the determined weights in the PRS activation request. If, for example, the determined weights associated with PRS configurations are included in the PRS activation request, the weights may indicate and/or be used to determine a preferred/desired PRS configuration that is based on the measurements made by the WTRU. In response to transmitting the PRS activation request that includes the respective weights, the WTRU may receive a new/updated configuration from the network.

A WTRU may be configured to transmit a request for a specific PRS configuration (e.g., a preferred PRS configuration). In response to requesting a specific PRS configuration, the WTRU may, based on the specified PRS configuration, receive an updated repetition factor for WTRU-based positioning. For example, the WTRU may be configured to determine to request a set of PRS resources for a set of TRPs (e.g., as described herein with respect to FIG. 3). The WTRU may also be configured to perform certain measurements, e.g., on a PRS transmitted from each TRP on the configured resources (e.g., time, frequency, and/or spatial resources). Based on the measurements performed by the WTRU, the WTRU may be configured to transmit a request that indicates a set of PRS resources to be used (e.g., a preferred set PRS resources) to the network (e.g., gNB, LMF).

A WTRU may be configured to determine a weight associated with each set of PRS resources. For example, the determined weights associated with each set of PRS resources may be included in the on-demand request transmitted by the WTRU. The weights determined to be associated with the PRS resource set may also, or alternatively, be associated with the PRS resources under the set. The WTRU may be configured to determine the associated weights with TRPs, and include the weights associated with TRPs in the on-demand request. In that case, PRS configurations associated with the TRP may be associated with the weight.

As described herein, a WTRU may be configured to determine the weights of selected PRS parameters associated with PRS activation request. For example, the WTRU may be configured to use the TRPs as a parameter for PRS activation requests. Other parameters may also, or alternatively be used, including, for example, PRS parameters, as described herein.

As described herein, training data may used to perform positioning. One or more of the following may apply. A WTRU may be configured to perform WTRU-based positioning. In certain WTRU-based positioning techniques, a WTRU may not perform and transmit measurements to the network.

As shown in FIG. 5, a WTRU 508 may perform measurements (e.g., RSRP measurements) on the PRS transmitted from one or more TRPs. A WTRU's location may change over. As the WTRU's location changes, the WTRU may receive PRSs from one or more TRPs. For example, as shown in FIG. 5, a WTRU 508 may be configured to measure an RSRP from 3 TRPs, TRPs 504, 505, 506. Referring to FIG. 5, at t=0 the WTRU 508 may be at location 0, and the WTRU 508 may measure RSRPs of −30 dBm, −40 dBm and −60 dBm from TRP 504, TRP 505 and TRP 506, respectively.

At t=T, the WTRU 508 may be at location 1.5, and the WTRU 508 may measure RSRPs of −30 dBm, −30 dBm and −60 dBm from TRP 505, TRP 506 and TRP 507, respectively. The RSRP measurements performed by the WTRU 508 may be used as training data. For example, the RSRP measurements may be input to an AI/ML model. Also, or alternatively, the locations of the respective TRPs, and/or the estimated location of the WTRU 508 may be input into the AI/ML modal. Based on the inputs, the AI/ML may be out weights associated with each of the TRPs. The WTRU 508 may then use the weights to transmit PRS requests, as described herein.

A WTRU may be configured to determine a set (e.g., an initial set) of TRPs to initiate an PRS activation request with. The WTRU may determine weights associated with each TRP, and the weights may be included in the PRS request. For example, the WTRU may determine an initial candidate to request a PRS, which may be based on the TRPs that are not part of the training data. Referring again to FIG. 5, the WTRU 508 may not perform measurements on a PRS from TRP 503, and, as a result, measurements for TRP 503 may not be included in the training data. If TRP 503 is not included in the training data, the WTRU 508 may determine (e.g., based on measurements associated with the PRS received from the WTRU 508) to include TRP 503 in the initial set of candidates for an PRS request. Similarly, since TRP 504 is not included in the training data, the WTRU 508 may also determine to include TRP 504 in the initial set of candidates for an PRS activation request.

A WTRU may determine weights associated with a given TRP, for example, based on measurements performed by the WTRU (e.g., RSRP measurement). Referring again to FIG. 5, if, for example, a WTRU 508 is located at position −0.5, the WTRU may be configured to transmit a PRS request to the network (e.g., LMF) transmit PRS from TRP 503 and/or TRP 504. Based on the measurements, the WTRU 508 may determine that the RSRP from a PRS received from TRP 504 is greater (e.g., greater than a PRS received from TRP 503). The WTRU 508 may also, or alternatively, determine that a higher probability of measuring a higher RSRP from TRP 504 exists (e.g., as opposed to TRP0). Based on the respective measurements, the WTRU 508 may be configured to determine weights associated with TRP 503 and TRP 504. And, based on determining that a higher probability of measuring a higher RSRP from TRP 504 exists, the determined weight associated with TRP 504 may be greater than the determined weight associated with TRP 503.

As described herein, a WTRU may determine the weights associated with various PRS configurations. For example, a WTRU may determine the weights associated with TRP candidates based on the difference between the measurements and training data. A correlation between training data and PRS measurements may exist. For example, a correlation between training data (e.g., as shown in FIG. 5) and measurements (e.g., as shown in FIG. 6) may exist. The WTRU may determine that PRS measurements from one TRP may be higher than another TRP, and the WTRU may determine that the weight of the TRP with a higher PRS measurement may be greater than the weight of the TRP with a lower PRS measurement.

A WTRU may determine the weights associated with TRP candidates based on a number of TRP candidates (e.g., the remaining number of TRP candidates). For example, if a single TRP candidate exists (e.g., the remaining number of TRP candidates is 1), the weight of that TRP candidate may be one (1).

A WTRU may determine the weights associated with PRS resources (e.g., beams) based on a line of sight (LOS) indicator. If, for example, the LOS indicator indicates a 50% likelihood of the presence of multiple paths, the WTRU may be configured to transmit requests for multiple beams, where each of the beams are associated with equal weights.

A WTRU may determine the weights associated with TRP candidates based on a respective TRP candidate's distance from the TRP that transmits PRS with a higher (e.g., the highest) RSRP.

The WTRU may receive weight configurations from the network. For example, the WTRU may receive a configuration from the network to return a value of either 0 or 1 associated with a given PRS configuration. Also, or alternatively, the WTRU may receive a range of weight values. For example, the range of weight values may be associated with a pre-defined granularity (e.g., [0, 0.1, 0.2, 0.3, . . . 1], where the minimum and maximum value of the range is 0 and 1, respectively, and granularity of the range is 0.1). The WTRU may be configured with a weight, for example, based on the WTRU's capabilities. For example, if the WTRU reports a capability of only being able to return 0 or 1, the WTRU may be configured (e.g., by the network) to indicate a weight of either 0 or 1.

A WTRU may be configured to determine weights associated with certain, PRS parameters associated with unobserved PRS resources. In certain scenarios, a WTRU may be configured to transmit a request (e.g., to the network) for PRS from resources that have not been measured by the WTRU. Prior to the transmitting the request, the WTRU may receive spatial information related to the PRS resources from the network. For example, the spatial information may indicate the direction that the PRS is transmitted from the gNB or TRP. Examples of spatial information include association of PRS resources with other DL reference signals (RS) or UL RS. For example, a PRS resource ID may be associated with a CSI-RS resource ID spatially, which may indicate that the CSI-RS and PRS are transmitted in a similar (e.g., the same) direction from the gNB. The WTRU may also, or alternatively, receive spatial relationship information that associates a PRS resource ID and SRS resource ID, which may indicate that the PRS and the SRS are transmitted in a similar (e.g., the same direction) from the gNB and WTRU, respectively. The WTRU may receive spatial relation information or QCL information (e.g., QCL-D which indicates quasi-co-location information of multiple reference signals and/or channels) from the network.

Spatial information may include boresight information. For example, boresight information may be provided on a per PRS resource basis from the network. The boresight information may indicate the direction that the PRS resource is transmitted from the gNB or TRP. The WTRU may also, or alternatively, receive information related to beam width for each PRS resource or beam characteristics (e.g., relative power difference per angle for each PRS resource). The WTRU may also receive an expected AoD and/or an expected AoA with respect to PRS resource(s).

Based on the received spatial information, the WTRU may be configured to determine to transmit a PRS request to the network that includes the associated weights. For example, the PRS request may include PRS resource IDs, PRS resource set IDs, TRP ID, and/or frequency layer ID.

Referring to FIG. 6, for example, a WTRU 602 may be configured with one or more PRS resources. For example, the WTRU 602 may be configured with PRS resource #1, #2 and #3 from TRP 601, where each of PRS resource #1, #2, and #3 belong to PRS resource set #1 (shown by vertical lines in FIG. 6). The WTRU 602 may also be configured with PRS resource #4 and #5 from TRP 601, where each of PRS resource #4 and #5 belong to PRS resource set #2 (shown by horizontal lines in FIG. 6). As shown in FIG. 6, each of PRS resource #1, #2, #3, #4, and #5 may be received from TRP 601. The WTRU 602 may be configured to perform WTRU-based positioning and may receive spatial information related to the PRS resources. The WTRU 602 may perform measurements (e.g., RSRP measurements) on PRS resource #1, #2 and #3. For example, the WTRU 602 may measure a higher RSRP from PRS resource #2 and #3, as compared to PRS resource #1. Based on the measurements (e.g., RSRP) and spatial information for each PRS resource, the WTRU 602 may be configured to determine that PRS resource #5 may yield a higher RSRP than PRS resource #4. For example, as described herein, the WTRU 602 may use an AI/ML model to determine that PRS resource #5 may yield a higher RSRP than PRS resource #4. The WTRU 602 may transmit a PRS request to the network to activate PRS resource #4 and #5. For example, the PRS request transmitted by the WTRU 602 may include the determined weights for each PRS resource (e.g., 0.2 for PRS resource #4 and 0.8 for PRS resource #5).

A WTRU may be configured to determine to request PRS resources (e.g., PRS resources form one or more TRPs) that fall within a certain AoD/AoA (e.g., the expected AoD/AoA of the received PRS resource). The PRS resources requested by the WTRU may belong to the same or different resource set and/or the same or different TRPs from the PRS resource. Referring again to FIG. 6, for example, the WTRU 602 may, for example, receive PRS resource #1 and PRS resource #2, and the WTRU 602 may measure a higher RSRP for PRS resource #1. Based on the expected AoD for PRS resource #1 and PRS resource #2, the WTRU 602 may be configured to determine that PRS resource #3 and #4 fall within the expected AoD of PRS resource #1 (e.g., PRS resource #3 and #4 have narrower beam compared to PRS resource #1). The WTRU 602 may also, or alternatively, determine that PRS resource #5 and #6 fall within the expected AoD of PRS resource #2. Based on the measured RSRP the WTRU 602 may be configured to determine to associate higher weights to PRS resource #3 and #4, as compared to PRS resource #5 and #6. Also, or alternatively, the WTRU 602 may be configured to transmit a request to activate PRS resource #3, #4, #5 and #6 based on the measured RSRP. As described herein, the request to activate PRS resource #3, #4, #5 and #6 that is transmitted by the WTRU 602 may include the determined weights for the respective PRS resources (e.g., the weights of PRS resource #3, #4, #5 and #6 are 0.4, 0.4, 0.1, 0.1, respectively).

A WTRU may be configured to determine to request PRS resources based on certain indicators associated with the PRS resource. For example, a WTRU may be configured to determine to request PRS resources based on the LOS indicator associated with PRS resource. The WTRU may receive certain indicators associated with a PRS resource, including, for example, LOS indicators. Referring again to FIG. 6, if, for example, PRS resource #1 is associated with a LOS indicator of 1, the WTRU 602 may determine that there is a LOS path along the direction of PRS resource #1. If, however, the LOS indicator is 0.1, the WTRU 602 may determine that there is a low likelihood that a LOS path along the direction of PRS resource #1 exists. The WTRU 602 may receive a signal from PRS resource #1 and PRS resource #2. The WTRU 620 may receive a LOS indicator for PRS resource #1 and PRS resource #2 with values of 0.8 and 0.1, respectively. Based on the expected AoD for PRS resource #1 and PRS resource #2, the WTRU 620 may determine that PRS resource #3 and #4 fall within the expected AoD of PRS resource #1 (e.g., the beam associated with PRS resource #3 and #4 is narrower than the beam associated with PRS resource #1). The WTRU 602 may also, or alternatively, determine that PRS resource #5 and/or PRS resource #6 fall within the expected AoD of PRS resource #2. Based on the LOS indicator for PRS resource #1 and PRS resource #2, and spatial information associated with PRS resource #3, PRS resource #4, PRS resource #5 and PRS resource #6, the WTRU 602 may assign higher weights to PRS resource #3 and #4, as compared to PRS resource #5 and PRS resource #6 in the request.

Although FIG. 6 illustrates an example where the WTRU 602 is configured to receive PRS from a singly TRP 601, it should be appreciated that the WTRU 602 may also be configured to receive PRS from multiple TRPs (e.g., as described herein). Similarly, the PRS resource sets may also, or alternatively, include PRS resources from one or more TRPs.

A WTRU may determine to transmit a PRS request, for example, when the WTRU is configured with multiple PRS resource sets (e.g., one resource set includes PRS resources with wide beams and another resource set includes PRS resources with finer beams). A WTRU may determine to transmit a request to terminate the PRS request procedure. For example, the WTRU may determine to transmit a request to terminate the PRS request procedure when there are no more PRS resources to request in a certain resource set (e.g., the resource set with the narrowest beamwidth).

A WTRU may transmit a PRS request associated with PRS measurements related parameters. For example, a WTRU may transmit a PRS request to turn on/off one or more TRPs. One or more of the following may apply.

A WTRU may transmit a PRS request to the network that indicates which TRPs should be turned on or off. As described herein, a PRS request to turn a given TRP on or off may refer to turning PRS for a given PRS resource associated with a TRP on or off, and/or turning PRS for one or more (e.g., all) PRS resources associated with a TRP. Based on the WTRU's request, the TRPs that are turned on may transmit PRS to the WTRU. The TRPs that are turned off may not transmit PRS to the WTRU. The PRS request transmitted by the WTRU may assign/associate a weight with each of the TRPs, and the respective weight of a TRP may indicate whether the TRP is to transmit PRS. For example, if the WTRU is configured to perform measurements on the PRSs receive from multiple TRPs (e.g., TRP1, TRP2 and TRP3), the PRS request transmitted by the WTRU may use the associated weight to indicate which TRPs should transmit PRS. For example, the PRS request may include respective weights of 1.0 for TRP1, 0.2 for TRP2 and 0 for TRP3. By transmitting such a PRS request, the WTRU may indicate that TRP1 should not transmit PRS, while TRP3 should continue to transmit PRS (e.g., with high certainty). Similarly, such a PRS request may indicate that the TRP2 should continue to transmit PRS, but that a certainty associated with TRP2 may be lower (e.g., slightly lower) than the certainty associated with TRP3.

In certain implementations, the WTRU may determine the weights associated/assigned to a respective TRP based on the measurements performed on PRS received from that TRP (e.g., RSRP) and/or channel condition (e.g., LOS indicator where LOS indicator of 1 or 0 indicates LOS or NLOS condition). For example, the WTRU may determine that the LOS indicator associated with TRP1 is 0, e.g., there is no line-of-sight between the WTRU and TRP1. Based on the performed measurement (e.g., RSRP) and/or determined channel condition (e.g., LOS indicator), the WTRU may associate a weight that turns PRS for TRP1 off (e.g., assign a weight of 1.0 to TRP1), e.g., since the WTRU expects relatively low RSRP/channel condition between WTRU and TRP1.

The WTRU may receive a configuration from the network that indicates how the WTRU should determine the respective weights for a given TRP. For example, the WTRU may be configured to use a combination of metrics to derive the respective TRP weights in a PRS request. In certain implementations, the WTRU may receive an indication from the network to use RSRP measurements and an LOS indicator that correspond to the PRS resource(s) received from a TRP to derive the respective weight associated with that TRP.

A WTRU may perform priority-based weight determinations for TRPs. One or more of the following may apply. For example, a WTRU may determine the weights for PRS requests based on the PRS priority level. The WTRU may receive a PRS priority level from the network (e.g., via a configuration associated with PRS). If the priority level is high, the WTRU may determine to process PRS measurements at higher priority (e.g., as compared to other DL signals or channels, such as PDCCH, PDSCH). The WTRU may determine to associate a weight for a request associated with PRS parameters if the PRS priority level is high. If, for example, PRS processing is configured at higher level (e.g., as compared to other DL signals or channels), the WTRU may be able to process weights associated with the request. If the PRS priority level is low, the WTRU may determine to transmit a PRS request without associated weight (e.g., due to lack of time to perform measurements).

A WTRU may transmit beam sweeping request to the network. One or more of the following may apply. The WTRU may transmit a request that includes a set of PRS resources and/or beams that the TRPs should transmit PRS on. The WTRU may associate/assign a weight in the request. For example, the set of requested PRS beams may be associated (e.g., spatially associated) with a PRS the WTRU performed measurements on. In certain implementations, the set of requested PRS beams may be narrower than the beams associated with the PRS the WTRU performed measurements on.

A WTRU may request that additional positioning techniques be employed, for example, to improve accuracy. One or more of the following may apply. A WTRU may transmit a request for a certain positioning technique that is associated with/assigned a weight. For example, the WTRU may be configured with a DL positioning method (e.g., DL-TDOA). Based on the measurements performed on PRS and/or the WTRU's estimated location, the WTRU may determine that additional positioning should be used, e.g., to improve accuracy of the WTRU's location estimate. Based on such a determination, the WTRU may request additional position techniques, for example, a PRS request that uses dedicated PRS resources (e.g., phase-based positioning).

The WTRU may assign a weight to the request for additional positioning techniques. For example, the WTRU may determine the weight assigned to the request based on a quality/accuracy associated with the location estimate obtained from previous positioning techniques. For example, if the standard deviation of the location estimate obtained from a previous positioning technique is higher or equal to a preconfigured threshold, the WTRU may transmit request for additional positioning techniques (e.g., phase-based positioning). The WTRU may determine the weight associated with the request for additional positioning techniques based on the standard deviation of the location estimate obtained from the previous positioning technique. In certain implementations, the WTRU may be configured (e.g., pre-configured) with a table that associates ranges of standard deviations with respective weights. For example, if the standard deviation is lower, the WTRU may associate/assign a lower weight to the request for additional positioning techniques. A request for additional positioning techniques (e.g., phase-based positioning) that is assigned a lower weight may indicate that the certainty of the request is lower.

In certain implementations, a WTRU may determine to transmit a request for additional positioning techniques based on RSRP measurements. For example, if the average RSRP of received PRS resources is greater than or equal to a threshold (e.g., a pre-configured threshold), the WTRU may determine to transmit the request for additional positioning techniques. As described herein, the weight associated with/assigned to request for positioning techniques may be based on configured (e.g., pre-configured) association rules between ranges of RSRP and weight value.

A WTRU may transmit a request for a measurement gap (MG) or PRS processing window that includes an associated weight. One or more of the following may apply. A WTRU may transmit a request to the network (e.g., gNB, LMF) for an MG and/or PRS processing window. During an MG, for example, the WTRU may not receive (e.g., may not expect to receive) DL channels (e.g., PDCCH, PDSCH) or signals. During a PRS processing window, for example, the WTRU may process (e.g., is expected to process) PRS, e.g., according to a configured PRS priority level. If the PRS priority level is lower than other DL signals or channels, the WTRU may not perform (e.g., is not expected to perform) measurements on the PRS(s) received during a PRS processing window.

A WTRU may determine whether to transmit a request for an MG or PRS processing window based on a PRS configuration. For example, the WTRU may determine to transmit a request to the network for an MG if the duration of PRS (e.g., number of symbols, slots, subframes, frames) is longer than a threshold (e.g., a pre-configured threshold). For example, if the number of slots configured for PRS is longer than the threshold, the WTRU may transmit a request for an MG. If the number of slots configured for PRS is shorter or equal to the threshold, the WTRU may determine to transmit a request for a PRS processing window. For example, the type of PRS processing window that the WTRU requests may depend on the WTRU's capability. In certain implementations, the WTRU may request a window where PRS prioritization is applied to the processing window based on the WTRU's processing capability. In certain implementation, the WTRU may request a processing window where PRS prioritization is applied to one or more PRS symbols/slots within the processing window.

A WTRU may transmit a request for a PRS processing window if, for example, the WTRU's request for an MG is not granted by the gNB. The WTRU may include a (e.g., desired) PRS priority level (e.g., high, medium, low) in the request. For example, the WTRU may transmit an MG and/or PRS processing window request to the network via UCI, UL-MAC-CE, RRC and/or LPP message.

The WTRU may associate/assign a weight to a request for an MG or PRS processing window. For example, the value of the associated weight may be determined based on a latency requirement and/or the frequency of a scheduled PDSCH or PDCCH. If, for example, the WTRU is configured with a periodic reception of PDSCH, the WTRU may determine to request for a measurement gap, associated with a weight 1.0, which may indicate that the request is transmitted with higher priority/certainty. As described herein, during the MG, the WTU may not receive downlink channels, which may allow the WTRU to perform PRS measurements. In certain implementations, the WTRU may associate a weight (e.g., a lower than 1.0) based on priority level of PDSCH. If the priority level associated with PDSCH is higher, the WTRU may associate a weight lower than 1.0, which may indicate a lower demand for an MG configuration.

In certain implementation, for example if the WTRU is not configured with a periodic or semi-persistent DL signals, PDCCH, and/or PDSCH, the WTRU may transmit a request for a PRS processing window. The WTRU may determine the weight associated with the processing window request based on frequency of the scheduled DL signals, PDSCH, and/or PDCCH. If the frequency of scheduled PDSCH or PDCCH is above or equal to a threshold (e.g., a pre-configured threshold), the WTRU may assign a weight of 1.0 to the PRS processing window request, which may indicate a higher demand for a PRS processing window from the WTRU. The WTRU may determine the weight for the request based on a configured (e.g., pre-configured) association rule between frequency of the scheduled PDSCH/PDCCH and weight values. For example, the configured association rules may assign higher weight values to higher frequency values for scheduled PDSCH/PDCCH. As described herein, the frequency of scheduled PDSCH and/or PDCCH may be measured by the number of slots/symbols/subframes/frames scheduled within a time window (e.g., 1 second). Based on the amount of time and/or frequency resources that the downlink channels occupy in a time window, the WTRU may determine the frequency of scheduled PDSCH and/or PDCCH.

In certain implementations, the value of the assigned weight may depend on the latency requirement for positioning. For example, if the latency requirement is below a (e.g., pre-configured) threshold, the WTRU may transmit an MG request. If the latency requirement is above or equal to the threshold, the WTRU may a PRS processing window request. The WTRU may determine the associated weight for the request based on an (e.g., pre-configured) association rule between the latency and weight. For example, the WTRU may be configured (e.g., pre-configured) with latency ranges and corresponding weights. For example, if the latency requirement is less than 1 second, the correspond weight may be 1.0. If, for example, the latency requirement is between 1 second and 10 seconds, the corresponding weight may be 0.5.

A WTRU may transmit a request for UL reference signals. One or more of the following may apply. In certain implementations, a WTRU may transmit a request for a configuration for SRS, PTRS, or SRS configurations. For example, the WTRU may determine whether to transmit the request for UL reference signals based on measurements made on DL PRS. The WTRU may transmit a request for a configuration for UL reference signals if, for example, the WTRU is configured with an RTT positioning method or UL-based positioning method (e.g., UL-TDOA). The WTRU may be configured (e.g., pre-configured) with a list of UL RS (e.g., SRSp) configurations, and the WTRU may determine a UL RS configuration from the list to request.

For example, the WTRU may determine to transmit a request for a SRSp configuration based on RSRP measurements made on PRS. If the RSRP corresponding to the PRS resource is above a (e.g., pre-configured) threshold, the WTRU may determine to request a certain SRSp configuration, for example, with higher time and/or frequency density. If the RSRP corresponding to the PRS resource is less than or equal to a (e.g., pre-configured) threshold, the WTRU may determine to request a certain SRSp configuration, for example, with lower time and/or frequency density. For example, the WTRU may be configured (e.g., pre-configured) with an association rule between a SRSp configuration and range(s) of RSRP for a DL PRS resource. In certain implementation, if the RSRP of the PRS resource falls within −70 dBm and −60 dBm, the corresponding repetition factor for SRSp may be 4. In certain implementations, if the RSRP of the PRS resource falls within −60 dBm and −50 dBm, the corresponding repetition factor for SRSp may be 2. The WTRU may determine the repetition factor for SRSp according to the rule. The WTRU may receive a configuration associating a PRS resource and SRSp resource. The WTRU may determine to transmit a request for a configuration for the SRSp resource based on measurements made on an associated PRS resource. The WTRU may associate a weight for the request, for example, based on measurements of PRS. For example, the WTRU may associate a weight for the request based on characteristics (e.g., statistical characteristics) of RSRP measurements on PRS (e.g., standard deviation of RSRP, variance of RSRP). The WTRU may be configured with an association rule of range(s) of standard deviations of RSRP and corresponding weights. The WTRU may determine the value of weight based on the association rule.

A WTRU may be configured to determine an estimated location. The WTRU may report the estimated location to the network. For example, the WTRU may include the estimated location in the message that includes a request for new/updated parameters from the WTRU. The WTRU may determine the estimated location based on training data (e.g., if training data is available to the WTRU). The WTRU may be configured to indicate how the estimated location is determined to the network. For example, the WTRU may be configured to indicate that the estimated location is determined based on training data.

Training data may be associated with certain information, including, timing information (e.g., a time stamp). If, for example, the training data is associated with a time stamp, the WTRU may be configured to associate the time stamp to the estimated location, which may indicate to the network how the estimated location was determined by the WTRU. The WTRU may also, or alternatively, be configured to associate the estimated location with the method used to determine the location estimate. For example, the WTRU may indicate a type of AI/ML model (e.g., supervised, un-supervised, and semi-supervised) used to determine the estimated location to the network. The WTRU may also include a time stamp in a PRS request (e.g., a request from WTRU to the network for new/updated PRS configurations), such that the network can associate the determined weights with time or relative/absolute timing when the request was sent from the WTRU.

As described herein, a WTRU may be configured to include certain information associated with the AI/ML model that is used to determine an estimated location. For example, a WTRU may be configured to include the amount of data (e.g., number of measurements, duration of training, etc.) that the AI/ML model has acquired and/or processed to determine the estimated location in the PRS request.

A WTRU may be configured to determine the weights for PRS parameters based on the predicted location of the WTRU. An example of predicated location may include the location of the WTRU after, for example, 10 ms from the current time. The predicted location of the WTRU may be determined by the WTRU based on mobility models. The WTRU may be configured (e.g., pre-configured) with one or more mobility models, including, e.g., straight, curve trajectory model) by the network. Based on a trajectory model, for example, the WTRU may be configured determine the predicted location of the WTRU at prediction interval T (e.g., expressed in terms of seconds, number of symbols, slots, subframes or frames) from the current time. For example, the prediction interval T may be configured (e.g., by the network). Based on the predicted location of the WTRU, the WTRU may be configured to determine weights and associate the determined weights with certain PRS parameters (e.g., spatial direction of PRS, periodicity, TRP IDs, etc.). The WTRU may be configured to transmit the PRS parameters and associated weights to the network. For example, the PRS parameters and associated weight may be included in a PRS parameters re-configuration request.

As described, a WTRU may be configured to determine weights associated with one or more PRS parameters. For example, the weights associated with the TRP candidates may be determined based on the likelihood/probability of WTRU receiving PRS from a given TRP candidate. For example, if, based on the predicted location of the WTRU, WTRU determines that the WTRU is likely to measure a higher RSRP from TRP0 and lower RSRP from TRP1, the WTRU may be configured to associate a higher weight to TRP0 than TRP1.

A WTRU may also, or alternatively, be configured to determine the weights for TRP candidates based on a predicted quality of future TRPs/PRS. For example, the associated weights that are determined by the WTRU may be associated with validity time. For example, a WTRU that measures a higher RSRP from TRP0 at time T may determine that the WTRU may measure a higher RSRP from TRP1 at time T+n. The WTRU may determine a first set of weights (e.g., a higher weight may be assigned to TRP0, as compared to TRP1). The first set of weights may be associated with a first time interval (e.g., time T to time T+n). The WTRU may determine a second set of weights (e.g., a higher weight may be assigned to TRP1, as compared to TRP0) that is associated with a second time interval (e.g., time T+n to time T+2n). The WTRU may be configured to include the two sets of weights in a separate message or in the same message. The WTRU may also be configured to indicate a reference time (e.g., T) and/or time window duration (e.g., n). The reference time and/or the time window duration may also, or alternatively, be configured and/or pre-configured by the network.

A WTRU and/or the network may be configured to determine new/updated PRS parameters based on the associated weights. A WTRU may be configured to determine new/updated PRS parameters based on the values of the weights associated with a given PRS request (e.g., if weights are above a threshold). FIGS. 7A-7C, for example, illustrates examples associated with a WTRU 703 being configured to determine weights associated with the PRS configurations included in a PRS request. As illustrated in FIGS. 7A-7C, a WTRU 703 may be able to receive PRS from TRPs 704, 705, 706, 707, 708. TRPs 704, 705, 706, 707, 708 may be located at position −1, 0, 1, 2, and 3, respectively. Using the PRS request techniques described herein, the WTRU 703 may receive a PRS configuration. The WTRU 703 may perform measurements (e.g., RSRP measurements) for each of the TRPs 704, 705, 706, 707, 708 (e.g., PRS received from TRPs 704, 705, 706, 707, 708). Based on the measurements, the WTRU 703 may transmit PRS requests the include requested PRS configurations. The WTRU 703 may receive the new/updated PRS configuration based on (e.g., in response to) the PRS requests transmitted by the WTRU 703.

As shown in FIG. 7A, the WTRU 703 may be configured to receive PRS from TRPs 706, 707, 708. The WTRU may perform measurements (e.g., RSRP measurements) on the PRS received from TRPs 706, 707, 708. For example, in the example illustrated in FIG. 7A, the WTRU 703 may measure an RSRP of −40, −60, and −60 for TRPs 706, 707, and 708, respectively. An estimated location associated with the WTRU 703 may then be determined based on the RSRP measurements. For example, as shown in FIG. 7A, the estimated location of the WTRU 703 may be determined to be position 1. As described herein, the WTRU may determine the estimated location using an AI/ML model. For example, the respective measurements (e.g., RSRP measurements) and/or location associated with the TRPs may by input to the AI/ML model. Based on the inputs, the AI/ML model may output an estimated location of the WTRU. As described herein, the AI/ML model may be installed/implemented at the WTRU and/or another device (e.g., a device associated with the network or network function).

As shown in FIG. 7A, the WTRU may transmit a PRS request to the network (e.g., a network function, such as the LMF 702) to receive PRS from TRPs 704, 705. The WTRU 703 may assign weights to each of the TRPs included in the PRS request and include the weights in the PRS request. For example, as shown in FIG. 7A, the WTRU 703 may assign a weight of 0.4 to TRP 704 and a weight of 0.6 to TRP 705. As described herein, the WTRU may determine the weights associated with the TRPs included in a PRS request based on an AI/ML model. For example, the respective measurements (e.g., RSRP measurements) and/or location associated with the TRPs may by input to the AI/ML model. Based on the inputs, the AI/ML model may output an estimated location of the WTRU. As described herein, the AI/ML model may be installed/implemented at the WTRU and/or another device (e.g., a device associated with the network or network function). If, for example, the AI/ML is implemented at another device, (e.g., a device associated with the network or network function), the WTRU may transmit the information to be input to the AI/ML model to the other device.

The new/updated PRS configuration may be based on the associated weights included in the PRS request transmitted by the WTRU 703. For example, if a weight associated with the PRS configuration is greater than or equal to a threshold, the WTRU 703 may be configured to determine that the WTRU 703 is likely to receive a new/updated PRS configuration. In an example, the WTRU 703 may be configured with a threshold of 0.5. Since the weight associated with TRP 705 is 0.6, the WTRU 703 may determine that the network is likely to activate TRP 705 (e.g., the WTRU 703 is likely to receive a new/update PRS configuration that indicates that PRS is to be transmitted from TRP 705). The WTRU 703 may also, or alternatively, be configured to transmit a request to stop PRS transmission from a given TRP, for example, based on measurements. Referring again to FIG. 7A, for example, the WTRU 703 may be configured to transmit a request to stop PRS on TRP 708 (e.g., due to TRP 708 having a lowest measured RSRP). The WTRU 703 may also, or alternatively, be configured to determine the activated and deactivated TRPs based on the PRS configuration received from the network (e.g., after the WTRU transmits the PRS request to the network). The WTRU 703 may be configured to receive new/updated PRS configurations from the network, for example, after the WTRU 703 transmits the PRS request that includes the weights associated with the relevant PRS parameters. For example, the WTRU 703 may not receive the requested PRS configurations (e.g., newly activated TRPs) from the network.

Referring again to FIG. 7A, if the WTRU 703 is configured with a threshold of 0.4 and the WTRU returns determines weights of 0.4 and 0.6 for TRP 704 and TRP 705, respectively, the network may configure both TRP 704 and TRP 705 to transmit PRS to the WTRU 703. The WTRU 703 may transmit a PRS request to the network to stop PRS transmission from TRP 707 and TRP 708 (e.g., due to TRP 707 and TRP 708 being associated with a lowest measured RSRP, as shown in FIG. 7A).

A WTRU may be configured to determine to include PRS parameters that are not part of the recent measurements. As shown in FIG. 7B, for example, the WTRU 703 may be configured to receive PRS from TRP 705, TRP2 and TRP3. At t=0, the WTRU may measure a low RSRP for the PRS transmitted from TRP 705. For example, as illustrated in FIG. 7B, the WTRU 703 may measure RSRP of −60 dbm, −40 dbm, and −60 dbm for TRPs 705, 706, and 707, respectively. Based on the RSRP measurements and/or location of the respective TRPs, the WTRU 703's estimated location may be determined to be position 0.5. As described herein, the location of the WTRU 703 may be estimated using an AI/ML model, which may be implemented at the WTRU 703 and/or another device (e.g., a device associated with the network or network function). If, for example, the AI/ML is implemented at another device, (e.g., a device associated with the network or network function), the WTRU may transmit the information to be input to the AI/ML model to the other device.

Based on a previous PRS request, for example, the WTRU 703 may transmit a PRS request to the network to transmit PRS from TRP 704. The weight for TRP 704 may be determined by the WTRU as described herein (e.g., using an AI/ML model). The list of candidate TRPs that the WTRU 703's PRS request may include TRP 704, TRP 705, TRP 706, TRP 707 and TRP 708. Since the WTRU 703 has already made measurements on TRP 705 through TRP 708, the WTRU 703 may measure (e.g., may only measure) PRS received from TRP 704. Also, (e.g., as TRP 704 may be the only TRP the WTRU 703 can request), the WTRU 703 may determine to assign a weight of 1 for TRP 704, and include that weight in the PRS request. Based on the PRS request, the WTRU 703 may receive an updated PRS configuration.

A WTRU may include additional PRS parameters in a PRS request. For example, as described herein, the WTRU may include the weights associated with TRPs that the WTRU requests that the network activates (e.g., receive PRS from) in a PRS request. The WTRU may also include periodicity value(s) for the PRS transmission from the requested TRPs in the PRS request (e.g., such that upon activation, PRS can be transmitted from a requested TRP at defined/requested periodicity). The WTRU may be configured to include a common periodicity for the requested TRPs, or different periodicities for each of the requested TRPs.

As shown in FIG. 7C, the WTRU 703 may receive an updated TRP/PRS configuration, e.g., based on the PRS request transmitted by the WTRU 703 in FIG. 7B. For example, the updated TRP/PRS configuration may activate PRS from TRP 704. As shown in FIG. 7C, the WTRU 703 may receive and perform measurements of the PRSs received from TRPs 704, 705, 706. The WTRU 703 may measure RSRPs of −30 dbm, −60 dbm, and −40 dbm for TRPs 704, 705, and 706, respectively. The location of the WTRU 703 may be estimated to be position 0.

A WTRU may be configured to terminate an on-demand PRS procedure. For example, after the WTRU has exhausted the PRS requests for the TRPs, the WTRU may determine to terminate the on-demand PRS procedure. The WTRU may terminate the PRS request procedure by transmitting a PRS termination request (e.g., to the network).

A WTRU may be configured PRS request limits. For example, the WTRU may be configured with a PRS request limit (e.g., a maximum number of PRS requests that may be transmitted by a WTRU). The WTRU may be configured to terminate an PRS activation request procedure (e.g., by transmitting a termination request, as described herein) if, for example, the number of PRS requests transmitted by the WTRU exceeds the PRS request limit. After terminating an PRS activation request procedure, the WTRU may continue to use the latest PRS configuration (e.g., the most recent PRS configuration that the WTRU received from the network).

A WTRU may be configured to perform weight validation. As described herein, a WTRU may determine the weights associated with certain PRS parameters, for example, based on: an AI/ML algorithm, past measurements, and/or pre-configured data. The WTRU may also be configured (e.g., by the network) with a validation period or area. If the WTRU is configured with a validation period by the network (e.g., LMF, gNB), the WTRU may be configured to start a timer in response to determining an initial set of PRS parameters. After the timer expires, the WTRU may be configured to transmit a request for additional training data for the AI/ML algorithm from the network (e.g., additional PRS configurations that that WTRU may perform measurements on). The WTRU may perform measurements on additional PRS configurations, which, as described herein, may be used as training data for the AI/ML algorithm. The WTRU may determine the weights associated with PRS parameters based on the AI/ML algorithm that incorporate the additional training data.

A WTRU may determine to transmit a PRS request to a TRP that is not included in the WTRU's PRS configuration. As described herein, a WTRU may be configured (e.g., pre-configured) with a set of PRS parameters that the WTRU may select from. The WTRU may indicate or include the selected PRS parameters in a PRS request. For example, the WTRU may determine to send a PRS request based on the pre-configured PRS parameters (e.g., the WTRU assigns a weight of 1 for the selected PRS parameters in the pre-configured set). The WTRU may also, or alternatively, determine to transmit a PRS request for a TRP that is not included in the set of pre-configured PRS parameters. For example, the WTRU may receive a pre-configuration that for a list of TRPs that includes TRP0, TRP1 and TRP2. The WTRU may determine to transmit a PRS request to the network to activate PRS from TRP0, TRP1 and/or TRP2. The WTRU may, however, determine to transmit a PRS request to activate PRS from TRP3 and TRP4, which may be outside of the pre-configuration. The WTRU may, for example, assign weights of 0.3 for TRP3 and 0.7 for TRP4. The WTRU may be configured to receive a system information block (SIB) or LPP message, which may include an indication (e.g., assistance data request message) from the network as to whether a PRS request within the pre-configured list of PRS parameters, or outside of the pre-configured list of PRS parameters may be transmitted).

In certain scenarios, the WTRU may not receive a pre-configured list of PRS parameters (e.g., in SIB or LPP message). If the WTRU does not receive a pre-configured list of PRS parameters, the WTRU may transmit a blind request. For example, the blind request may include specific information/IDs associated with any of the PRS parameters/configurations supported by the network. In The blind request may also include the weights associated with PRS parameters, which may indicate the WTRU's desired/preferred PRS parameters. The weight value may indicate the level of preference towards a PRS parameter, for example. The WTRU may also, or alternatively, transmit a blind request when, for example, the WTRU receives an indication/request from network for the WTRU to transmit a blind request.

The WTRU may be associated with valid and/or invalid PRS configurations. For example, a PRS configuration may be invalid due to expiration of an associated timer and/or the WTRU is in the area where the PRS configuration is not associated with the validity area (e.g., the PRS configuration is not associated with the cell the WTRU is located in). The WTRU may determine to associate weights with the PRS configurations that are not part of the valid PRS configurations.

As described herein, a WTRU may be configured to initiate and/or terminate an PRS activation request procedure. For example, a WTRU may transmit PRS requests periodically, semi-persistently, and/or aperiodically. A WTRU may terminate an PRS activation request procedure, for example, in response to one or more conditions.

A WTRU may be configured (e.g., by the network) to transmit PRS activation requests periodically, semi-persistently, and/or a periodically. For example, the WTRU may be configured with the periodicity of PRS request transmissions (e.g., occasion) by the network. If the WTRU determines to transmit an PRS activation request (e.g., as described herein), the WTRU may determine to transmit a PRS request that includes the associated weights based on the configured periodicity.

An PRS activation request procedure may be triggered by the network. For example, a WTRU may receive an activation command (e.g., via DCI or MAC-CE), where the activation command may be configured to trigger/initiate an PRS activation request procedure (e.g., a PRS request trigger). The WTRU may be configured with the periodicity at which the WTRU can transmit PRS activation requests.

A WTRU may be configured to initiate an on-demand PRS procedure by transiting a trigger, such as, a MAC-CE. In response to transmitting the MAC-CR, the WTRU may receive an acknowledgement or refusal from the network to initiate the on-demand request procedure. For example, the network may transmit a deactivation command (e.g., via a MAC-CE), which may indicate that the network has refused to initiate the on-demand PRS-request. After the WTRU receives a deactivation command from the network, e.g., via a MAC-CE, the WTRU may determine to terminate the on-demand request procedure.

In certain scenarios, a WTRU may terminate an PRS activation request procedure, if the WTRU does not have any more parameters to request (e.g., the WTRU does not have any more TRPs from which to request PRS). For example, if there is no more TRP left to request PRS transmission, the WTRU may transmit an indication (e.g., a request) to terminate an PRS activation request procedure to the network. The WTRU may also, or alternatively, determine to terminate an PRS activation request procedure if one of the weights associated with PRS configurations is above a threshold (e.g., a pre-configured threshold). For example, a weight being above the threshold may indicate a level of certainty in the WTRU's request. The WTRU may also, or alternatively. terminate an PRS activation request procedure if the weights associated with PRS configurations (e.g., all of the associated weights) are below a threshold (e.g., a pre-configured threshold). For example, the weights (e.g., all of the associated weights) being below the threshold may indicate a level of uncertainty in the WTRU's request.

In another example, the WTRU may receive a configuration for a time window from the network during which the WTRU can make an on-demand request for PRS configurations. The configurations related to the time window may be start and/or end time of the window, duration of the window (e.g., in terms of symbols, slots, frames, milliseconds).

A WTRU may be configured to perform an PRS activation request procedure a certain period of time. For example, a WTRU may start/initiate a timer when the WTRU initiates an PRS activation request procedure (e.g., in response to receiving an activation command via MAC-CE). The WTRU may receive an expiration time for the timer, which may indicate the period of time over which the WTRU may perform an PRS activation request procedure. While the timer is active, the WTRU may transmit PRS activation request that include the associated weights (e.g., at configured periodicity), as described herein. After the timer expires, the WTRU may terminate the on-demand request procedure.

A WTRU may receive a trigger (e.g., via DCI) from the network to transmit an PRS activation request. In response to receiving the triggers, the WTRU may transmit an on-demand PRS request that includes the associated weights, as described herein.

A WTRU may receive an indication from the network to change/update one or more configurations associated with an PRS activation request procedure: increase/decrease frequency of transmission (e.g., periodicity) of PRS requests; limit the associated weight values (e.g., an upper bound for the weight value); weights normalization based on one or more criteria (e.g., the maximum value of the weight is 1, average of the weights is 0.5, etc.)

In certain scenarios, a WTRU may transmit an PRS activation request to the network in response to one or more of the conditions to trigger an PRS activation request are met. As described herein, the conditions that trigger an PRS activation request procedure may be configured by the network. The WTRU may also, or alternatively, transmit an PRS activation request in the absence of pre-configured conditions.

A WTRU may receive an indication from the network to provide certain information associated with an PRS activation request procedure. For example, the WTRU may receive a request to return a PRS request that includes the associated weights associated for the requested PRS configurations and a list and respective locations of TRPs that the WTRU can receive PRS from. The WTRU may be configured with a set of TRPs from which it may receive/request PRS. The WTRU may perform measurements (e.g., RSRP measurements) on the PRSs from the respective TRPs. The WTRU may determines that one or more TRPs that are not part of the set configured TRPs (e.g., TRPs from which PRS is received/measured by the WTRU) are candidate TRPs. If the average RSRP of the PRSs received from the configured TRPs is below a threshold, the WTRU return respective weights for each of the candidate TRPs to the network. For example, the respective weights for each of the candidate TRPs may be determined by the WTRU based on a given TRP's proximity to the WTRU (e.g., how close a given TRP is to the TRP with a highest measured RSRP). Based on this information, the WTRU may determine and returns an estimated position of the WTRU. Based on the estimated position of the WTRU, the WTRU may receive a new/updated set of TRPs from which PRS is to be received. The WTRU may receive and perform measurements on the respective PRSs from the updated set of TRPs. The WTRU may continue to measure PRSs, determine a set of candidate TRPs, and determine an estimated location/position of the WTRU until the average RSRP of the set of configured TRPs is above the threshold. The WTRU may maintain the number of iterations that the WTRU measures PRSs, determines a set of candidate TRPs, and determines an estimated location/position. If the number of iterations is above a threshold, the WTRU requests a termination of the PRS activation request procedure.

A WTRU may perform certain fallback and rejection techniques associated with an PRS activation request procedure. For example, a WTRU may transition to a default on-demand procedure (e.g., request for a specific PRS parameter or specific set of PRS parameters) and/or non-on-demand procedure if one or more of the following conditions are met: the WTRU determines to terminate the on-demand request procedure, as described herein; a timer associated with an PRS activation request procedure expires; there are no more PRS parameters (e.g., TRPs) to associate the weights with; the WTRU receives a rejection message from the network (e.g., gNB, LMF) in response to a transmitted PRS activation request.

After a WTRU terminates an PRS activation request procedure, the WTRU may continues to use the latest PRS configuration it has received from the network. Also, or alternatively, after the WTRU terminates an on-demand PRS procedure, the WTRU may determine to transmit a request for a specific PRS parameter or specific set of PRS parameters. The WTRU may determine to use the PRS configuration that the WTRU receives from the network.

A WTRU may determine to terminate an PRS activation request procedure. If the WTRU determine to terminate an PRS activation request procedure (e.g., in response to receiving a rejection message from the network) the WTRU may use: a default positioning procedure (e.g., an on-demand and/or non-on-demand PRS procedure); a default PRS configuration; and/or or previous PRS configuration. If the WTRU determine to terminate an PRS activation request procedure, the WTRU may be configured by the network to perform one of the techniques described herein. If the WTRU determine to terminate an PRS activation request procedure, the WTRU may transmit a request for a specific PRS configuration parameter or parameter set (e.g., without an associated weight).

As described herein, a network may reject an PRS activation request, for example, by transmitting a rejection message to the WTRU. For example, the rejection message from the network may be explicit or implicit. The WTRU may receive an explicit rejection message in response to transmitting an PRS activation request to the network. The WTRU may receive a rejection message that is associated with one or more of the PRS parameters that the WTRU transmits to the network. For example, the WTRU may determine to transmit another PRS activation request that includes different PRS parameters and associated weights.

A WTRU may determine that the network has rejected an PRS activation request if, for example, a PRS from one of the requested PRS parameters (e.g., a PRS from one of the requested TRPs) is not received within a certain amount of time (e.g., a pre-configured time window). The WTRU may start/initiate a timer after the WTRU transmits an PRS activation request to the network. If the WTRU does not receive a PRS configuration before the timer expires, the WTRU may determine that the PRS activation request was rejected by the network.

A WTRU may transition to/from a WTRU-based positioning and/or WTRU-assisted positioning. A WTRU may determine to switch from WTRU-based positioning to WTRU-assisted positioning in one or more of the following scenarios: the WTRU receives an indication from the network to switch/from WTRU-based positioning and/or WTRU-assisted positioning; the WTRU determines that quality of measurements (e.g., RSRP) for PRS configured by the network is below the threshold; and/or the WTRU determined that a variation of measurements (e.g., variance/standard deviation of RSRP, RSTD) for PRS configured by the network is above the threshold.

After a WTRU transitions from WTRU-based to/from WTRU-assisted positioning, the WTRU may transmit certain measurements. For example, the measurements may be based on the PRS parameters that are configured by the network. The PRS parameters configured by the network may be effective/valid for a configured duration of time. The WTRU may be configured with a time window during which the WTRU perform measurements on the received PRS and return them to the network. The WTRU may be configured with the semi-persistent and/or aperiodic PRS, and the WTRU may perform measurements on the semi-persistent and/or aperiodic PRS. The WTRU may return the measurements to the network (e.g., for a configured duration of time), which may assist the network to train the AI/ML model that may be used to perform positioning.

In certain scenarios, a WTRU may obtain a set (e.g., subset) of PRS configurations from the network (e.g., TRP ID, TRP locations, etc.). For example, a subset of PRS configurations may be based on a hierarchical structure (e.g., the hierarchical structure 400 shown in FIG. 4). The WTRU may receive a first (e.g., initial) PRS configuration from the network (e.g., TRP locations, periodicity of PRS, etc.). The WTRU may also, or alternatively, receive a set of TRP locations from the network.

Based on the first (e.g., initial) PRS configuration received from the network, the WTRU may determine the WTRU's location. Based on the WTRU's location, the WTRU may determine which TRP(s) to activate for PRS transmission. The WTRU may receive a set of TRPs for which to activate PRS transmission. The WTRU may determine the TRPs to activate from the set. The WTRU may send a PRS configuration request to configure one or more PRS parameters other than TRPs, e.g., frequency layer, PRS resource, PRS resource set, and/or the like.

In certain scenarios, a WTRU may send a request to activate a given PRS configuration. The network may activate the requested PRS configuration and return one or more PRS parameters associated with the requested PRS configuration. For example, the WTRU may request to activate TRP(s). As an acknowledgment message from the network (e.g., LMF, gNB), the WTRU may receive PRS configurations (e.g., number of PRS symbols/slots, periodicity, spatial information) associated with the activated TRP(s) from the network. In another example, the WTRU may request to activate one or more frequency layer(s). As an acknowledgment message to the request to activate a frequency layer, the WTRU may receive PRS configurations associated with the activated frequency layer(s) from the network.

A WTRU may send one or more requests to the network. For example, each request may be associated with a given layer in a PRS configuration hierarchy (e.g., the PRS configuration hierarchy illustrated in FIG. 4). In certain scenarios, the WTRU may send a request to activate one or more frequency layers. The WTRU may receive a list of TRPs that are able to be activated under the activated frequency layer(s), which may be considered as an acknowledgement to the activation request. The WTRU may further determine which TRPs of the list to activate and send a request to activate the selected TRP(s). In response to the request to activate the selected TRP(s), the WTRU may receive PRS configuration associated with the activated TRP(s) from the network, which may be considered as an acknowledgement to the TRP activation request.

The WTRU may receive a list of available (e.g., potential) PRS configurations (e.g., TRPs, frequency layers, etc.). The WTRU may determine to send a request to activate a subset of available PRS configurations. The activated PRS configurations may be referred to as activated (e.g., actual) PRS configurations.

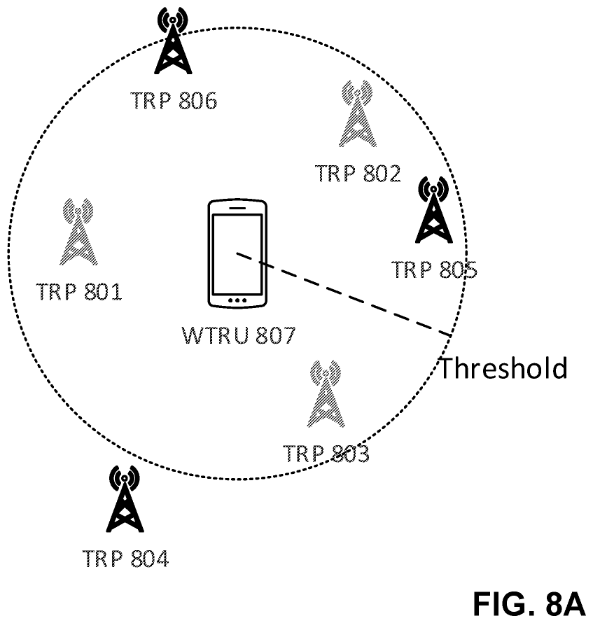

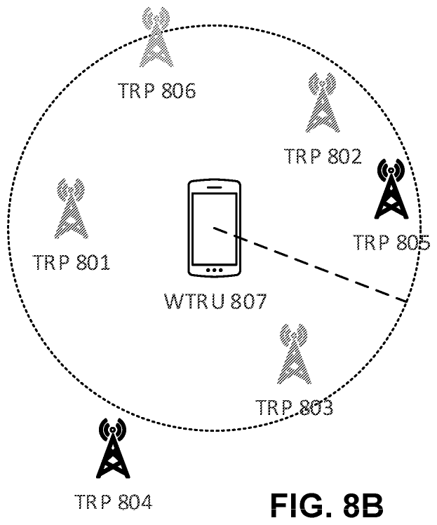

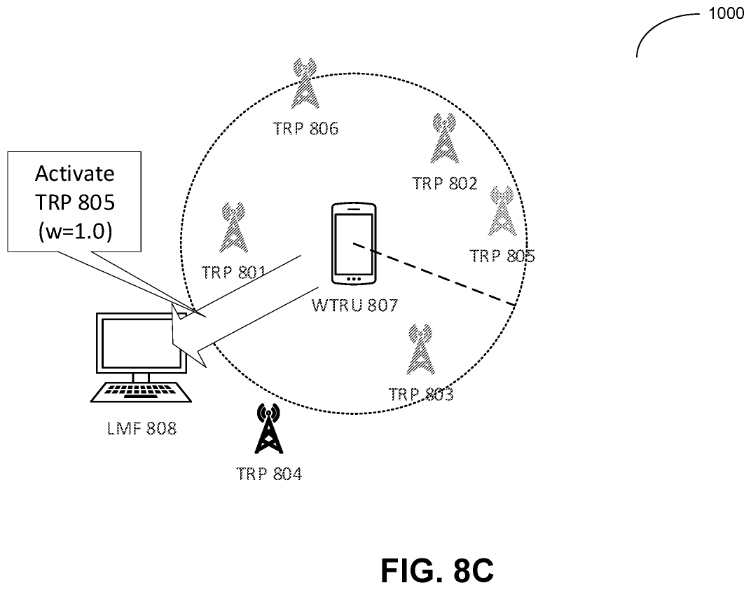

The WTRU may use a criteria for selecting the TRP(s) to activate (e.g., a selection criteria). One or more of the following may apply. The selection criteria for TRP(s) may be based on the distance between TRP and the WTRU's location (e.g., the WTRU's current location). For example, the WTRU may determine to activate the TRPs whose distance from the WTRU location is less than or equal to a threshold, for example, as illustrated in FIG. 8A.

As shown in FIG. 8A, a WTRU 807 may be configured (e.g., initially configured) with TRP 801, TRP 802 and TRP 803. The WTRU 807 may determine to send a PRS request to the network to activate additional TRPs. The WTRU 807 may determine its position based on measurements made on the PRS(s) transmitted from TRP 801, TRP 802 and TRP 803, for example, using the techniques described herein (e.g., an AI/ML model). The WTRU 807 may determine to send a request to the network to activate TRP 805 and/or TRP 806, for example, based on a threshold (e.g., a pre-configured threshold), which is shown by the circle in FIG. 8A. For example, the threshold may be a distance threshold and/or a measurement (e.g., RSRP) threshold. As shown in FIG. 8A, the WTRU 807 may not determine to activate TRP 804, as TRP 804 is outside of the threshold.

A WTRU may perform measurements (e.g., RSRP), e.g., of reference signals (e.g., PRS, CSI-RS) or signals (e.g., SSB) from one or more TRP(s) (e.g., potential TRPs). The WTRU may determine to send an activation request associated with the TRPs if, for example, the RSRP of the reference signals/signals from that TRP is above a threshold.

As described herein, a WTRU may determine a threshold distance (e.g., a threshold distance between a given TRP and the WTRU) which may be used to identify TRP(s) to activate. For example, the threshold distance may be configured (e.g., pre-configured by the network). Also, or alternatively, the threshold distance may be determined based on a look-up table (e.g., a look-up table that associates RSRP of PRS resource(s) and thresholds). For example, the look-up table may include an RSRP of a reference PRS and/or an average RSRP of PRS resources from a reference TRP that is associated with a threshold. In certain scenarios, a lower value of RSRP may correspond to lower threshold value.

A WTRU may be configured with one or more parameters (e.g., conditions) for sending an PRS activation request (e.g., a request to activate PRS and/or a PRS resource from a TRP). One or more of the following may apply. A WTRU may determine to send activation request to the network to activate PRS from additional TRPs. e.g., if the measured RSRP associated with a PRS received from a TRP (e.g., a reference TRP) is below a threshold. For example, the reference TRP may be configured, e.g., by the network. A WTRU may determine to send activation request to the network to activate additional TRPs if the RSRP measured for a reference PRS (e.g., a PRS preconfigured by the network) is below a threshold. The WTRU may determine to send activation request to the network to activate additional TRPs if the minimum, maximum, and/or average PRS per TRP (e.g., reference TRP) is below the threshold. A WTRU may determine to send activation request to the network to activate additional TRPs if the minimum maximum, and/or average PRS resources of a configured TRPs is below the threshold. A WTRU may determine to send an activation request to the network to activate additional TRPs if the WTRU receives an indication/configuration from the network to request for additional TRPs. For example, the indication/configuration may include a condition (e.g., a preconfigured condition), and the WTRU may transmit the activation request if the condition is satisfied. WTRU may determine to send an activation request to the network to activate additional TRPs if a LOS indicator/NLOS indicator for a PRS/TRP is below/above the threshold. For example, if the LOS indicator (e.g., an indication of the likelihood of an LOS path between the WTRU and TRP exists) associated with a TRP is below the threshold, the WTRU may send a request to the network to activate additional TRPs. As described herein, RSRP may be interchangeably used with RSRP per path (e.g., when multiple paths exist between the WTRU and TRP).

A WTRU may determine weights associated with each PRS activation request, e.g., after the requested TRPs are activated. The WTRU may determine weights for each TRP, for example, based on the distance from the WTRU location and the respective TRP. For example, the weights of each of the TRPs requested for activation may add up to 1. In certain scenarios, the weights may be determined based on a ratio (e.g., a ratio of the distances between the WTRU and the TRPs). Referring to the example illustrated in FIG. 8A, if TRP 805 and/or TRP 806 are located at equal distance from the WTRU 807, the WTRU 807 may determine to assign the same weight, e.g., 0.5 for TRP 805 and TRP 806. If, for example, the distance between WTRU 807 and TRP 805 and TRP 806 are 1 meter and 3 meters, respectively, the WTRU 807 may determine weights for TRP 805 and TRP 806 of 0.75 and 0.25, respectively (e.g., indicating the WTRU 807's preference to activate a TRP 805, which is geographically closer to the WTRU).

The weights associated with the TRPs may be determined based on the number of TRPs to activate. For example, if the number of TRPs to activate is N, and the distances between the TRPs and WTRU are equal, the WTRU may determine to set a weight for each weight as 1/N.

In examples, the weights for a request may be determined based on an AI/ML model. For example, the AIML model may be trained at the WTRU based on measurements (e.g., RSRP, RSTD) made from PRSs. For example, a target metric used during training may include PRS configurations (e.g., TRP) and/or the associated weights (e.g., 1.0 for activation, 0.0 for deactivation). The PRS configuration to activate may include a set of TRPs that are available for activation. The WTRU may receive the set of PRS configurations (e.g., TRPs) from the network. For example, the set of PRS configurations may be based on the request from the WTRU. Based on the trained AIML model, the WTRU may obtain metrics (e.g., weights) associated with the requests. For example, the metrics (e.g., weights) associated with the requests may be based on measurements made from the PRS configurations (e.g., initial/default PRS configuration).

A WTRU may receive PRS configurations associated with the requested TRPs (e.g., in response to an activation request transmitted to the network). The WTRU may receive the PRS configuration and/or ACK/NACK messages corresponding to the request from the WTRU (e.g., from the network). For example, the PRS configuration that the WTRU receives from the network may, for example, include periodicity of PRS, number of symbols for PRS, bandwidth, and/or the like.

FIG. 8B illustrates an example associated with receiving PRS configurations for activated TRPs (e.g., newly activated TRPs). Referring to FIG. 8B, the WTRU 807 may be configured to receive PRS from TRPs 801, 802, 803. The WTRU 807 may receive PRS configuration (e.g., spatial information, number of symbols, periodicity, etc.) for newly activated TRPs from the network. For example, as shown in FIG. 8B, the WTRU 807 may receive a PRS configuration to activate PRS from TRP 806. As shown, the WTRU 807 may not receive a PRS configuration for TRP 805, which may indicate that the activation request for TRP 805 was rejected (e.g., the network did not grant the request to activate TRP 805 from the WTRU 907).

A WTRU may perform maintenance on the set TRPs from which PRS may be received. For example, once the requested TRPs are activated, a WTRU may remove the newly activated TRPs from the set of configured TRPs (e.g., preconfigured TRPs), which may prevent the WTRU from requesting to activate the TRPs again.

A WTRU may send (e.g., continue to send) activation requests until, for example, one or more conditions are satisfied. The WTRU may send (e.g., continue to send) activation requests if the set of TRPs available for activation is empty. The WTRU may send (e.g., continue to send) activation requests if a condition to stop sending requests is satisfied (e.g., RSRP of the reference PRS is above a threshold). The WTRU may send (e.g., continue to send) activation requests if the WTRU receives a command (e.g., a deactivation command received from the network to stop the request procedure). The WTRU may send (e.g., continue to send) activation requests until the number of acknowledgments and/or non-acknowledgments to activation requests sent by the WTRU is above or equal to the threshold. The WTRU may send (e.g., continue to send) activation requests if a time window/duration for on-demand PRS is expired.

FIG. 8C illustrates an example associated with activation requests sent by a WTRU. One or more of the following may apply. For example, as illustrated in FIG. 8C, the WTRU 807 may send an another PRS activation request to the network (e.g., or network function, such as the LMF 808) to activate TRP 805. For example, TRP 805 may not have been activated in response to a previous activation request sent by the WTRU 807 (e.g., as described herein with respect to FIG. 8A). The WTRU 807 may determine to associate a weight of 1.0 for TRP 805 and include that weight in the PRS request transmitted to the network, as shown in FIG. 8C. For example, the WTRU 807 may assign a weight of 1.0 to TRP 805 because TRP 805 is the only TRP within the configured threshold (e.g., the only TRP available for activation). For example, the WTRU may periodically send activation requests (e.g., at a configured periodicity) until one of conditions described herein are satisfied. The WTRU may send the request using a configured uplink grant and/or a dynamic uplink grant.

In examples, a WTRU may determine to terminate a PRS request procedure. For example, the WTRU may determine to terminate an on-demand procedure if a subset of the requested PRS configurations is granted by the network. The WTRU may determine to send a request to cancel activation requests for the remaining subset(s) of PRS configurations (e.g., the PRS configurations that are not yet activated). For example, referring again to FIG. 8C, the WTRU 807 may receive an indication that only TRP 806 is activated (e.g., even though the WTRU 807 has requested for activation of TRP 805 and TRP 806). In this case, if the WTRU 807 determines that TRP 806 is activated, the WTRU 807 may determine to terminate the PRS request procedure and/or send a message to the network to cancel the request for activation of TRP 805.

In certain scenarios, a WTRU may receive a first PRS configuration from the network. The WTRU may receive a set of PRS configurations (e.g., TRP location, etc.) from the network. The WTRU may receive PRS from one or more TRPs based on the first PRS configuration. The WTRU may performed measurements on the received PRS. The WTRU may determine its location, for example, based on the measurement (e.g., RSRP, RSTD) of PRS received from the TRP using the first PRS configuration. For example, the WTRU may determine its location using an AI/ML model. Based on the WTRU's location, the TRP's location, and/or the PRS measurements, the WTRU may determine a weight for each PRS configuration in the set of PRS configurations received from the network. As described herein, the WTRU may use an AI/ML model to determine the weight for each PRS configuration in the set of PRS configurations from the network. For example, the WTRU may determine a higher weight for PRS configurations that include TRP closer to the WTRU location. As described herein, the determined weights for each of the PRS configuration in the set may add up to 1. The WTRU may send a PRS request to the network. For example, the PRS request may include the determined weights associated with each PRS configurations (e.g., each PRS configurations in the set). The WTRU may receive a PRS resource configuration to activate (e.g., PRS resources, spatial information, etc.) from the network. The received PRS configuration that is to be activated may be based on the PRS request transmitted by the WTRU and/or the weights associated with each of the PRS configurations in the set. For example, the received PRS configuration that is to be activated may be the PRS configuration that is associated with the highest weight. Also, or alternatively, the received PRS configuration that is to be activated may be PRS configuration that is associated with a weight that is above a threshold. The WTRU may remove the PRS configuration that is to be activated the set. The WTRU may determine its position, for example, based on the received PRS resource configuration. The WTRU may report its location and/or a PRS configuration ID to the network. The WTRU continue to receive PRS configurations, determine its position, and report to the network, for example, until the set or PRS configurations is empty.

A WTRU may determine to send differential locations. As described herein, a differential location may be defined as the difference between a location and reference location. For example, if a coordinate of a location and reference location are represented by (x, y) and (x1, y1), respectively, the differential location may be represented as (x1−x, y1−y). A WTRU may determine to send a differential location and/or the reference location. One or more of the following may apply. The WTRU may determine to send a differential location and/or the reference location if the differential location is determined based on newly activated TRPs (e.g., TRP 806, referring to the example illustrated in FIGS. 8A-8C). Also, or alternatively, the WTRU may determine to send a differential location and/or the reference location if the PRS configurations and the reference location is determined based on the initial set of TRPs (e.g., TRP 801, TRP 802, TRP 803 referring to the example illustrated in FIGS. 8A-8C). The WTRU may determine to send a differential location and/or the reference location if the location is determined based on the combination of newly activated TRPs/PRS configurations and an initial set of TRPs/PRS configurations (e.g., TRP 801, TRP 802, TRP 803 and TRP 806, referring to the example illustrated in FIGS. 8A-8C) and/or if reference location is determined based on the initial set of TRPs/configurations.

What is claimed:

1. A wireless transmit/receive unit (WTRU) comprising a processor and a memory, the processor and the memory configured to:
receive configuration information indicating that the WTRU is configured to receive positioning reference signals (PRSs) from a first set of one or more transmission-reception points (TRPs), the configuration information comprising positioning reference signal (PRS) configuration information associated with the first set of one or more TRPs;
determine a metric associated with a transmission-reception point (TRP), wherein the TRP is not included in the first set of one or more TRPs, the determined metric being based on one or more of:
a location associated with the TRP,
a location associated with the WTRU, or
a measurement associated with the TRP;
send a PRS activation request to activate PRS from the TRP, wherein the PRS activation request includes the determined metric associated with the TRP; and
receive a message indicating the WTRU is to receive PRS from the TRP, the message comprising PRS configuration information associated with the TRP.

2. The WTRU of claim 1, wherein the metric comprises a weight, wherein the processor and the memory are configured to:
determine a respective weight for each TRP of a second set of one or more TRPs, wherein WTRU is not configured to receive PRS from each TRP of the second set of one or more TRPs, and wherein the PRS activation request further includes the respective weight determined for each TRP of the second set of one or more TRPs.

3. The WTRU of claim 1, further comprising:
receive PRS from the first set of one or more TRPs; and
determine the location associated with the WTRU based on the PRS received from the first set of one or more TRPs.

4. The WTRU of claim 3, wherein the processor and the memory are configured to:
determine an estimated location associated with the WTRU based on PRS received from the TRP; and
send an indication of the estimated location associated with the WTRU.

5. The WTRU of claim 4, wherein the indication of the estimated location associated with the WTRU is signaled as a differential value relative to the determined location associated with the WTRU based on the PRS received from the first set of one or more TRPs.

6. The WTRU of claim 4, wherein the estimated location associated with the WTRU is determined using an artificial intelligence/machine learning (AI/ML) model.

7. The WTRU of claim 4, wherein the processor and the memory are configured to:
send a second PRS activation request, wherein the estimated location associated with the WTRU is included the second PRS activation request.

8. The WTRU of claim 1, wherein the measurement associated with the TRP comprises at least one of a reference signal received power (RSRP) measurement, a line of sight (LOS) measurement, a non-line of sight (NLOS) measurement, a distance measurement, or a timing measurement.

9. The WTRU of claim 1, wherein the weight associated with the TRP is determined using an artificial intelligence/machine learning (AI/ML) model.

10. The WTRU of claim 1, wherein the PRS configuration information comprising PRS configuration information for each of the first set of TRPs.

11. A method implemented by a wireless transmit/receive unit (WTRU), the method comprising:
receiving configuration information indicating that the WTRU is configured to receive positioning reference signals (PRSs) from a first set of one or more transmission-reception points (TRPs), the configuration information comprising positioning reference signal (PRS) configuration information associated with the first set of one or more TRPs;
determining a metric associated with a transmission-reception point (TRP), wherein the TRP is not included in the first set of one or more TRPs, the determined metric being based on one or more of:
a location associated with the TRP,
a location associated with the WTRU, or
a measurement associated with the TRP;
sending a PRS activation request to activate PRS from the TRP, wherein the PRS activation request includes the determined metric associated with the TRP; and
receiving a message indicating the WTRU is to receive PRS from the TRP, the message comprising PRS configuration information associated with the TRP.

12. The method of claim 11, wherein the metric is determined using an artificial intelligence/machine learning (AI/ML) model.

13. A base station comprising a processor and a memory, the processor and the memory configured to:
transmit configuration information indicating that a wireless transmit/receive unit (WTRU) is configured to receive positioning reference signals (PRSs) from a first set of one or more transmission-reception points (TRPs), the configuration information comprising positioning reference signal (PRS) configuration information associated with the first set of TRPs;
receive a PRS activation request to activate PRS from a transmission-reception point (TRP) that is not included in the first set of one or more TRPs, wherein the PRS activation request includes a metric associated with the TRP; and
transmit a message indicating that the WTRU is to receive PRS from the TRP, the message comprising PRS configuration information associated with the TRP.

14. The base station of claim 13, wherein the metric associated with the TRP is determined metric based on one or more of:
a location associated with the TRP,
a location associated with the WTRU, or
a measurement associated with the TRP.

15. The base station of claim 13, wherein the processor and the memory are further configured to determine whether to accept the received PRS activation request based on an artificial intelligence/machine learning (AI/ML) model.
